(19) United States
(12) Patent Application Publication
(10) Pub. No.: US 2024/0013113 A1
(43) Pub. Date: Jan. 11, 2024

(54) METHOD AND SYSTEM FOR AUTOMATIC ESTABLISHMENT OF OPTIMAL SCHEDULE FOR CONSTRUCTION PROJECT

(71) Applicant: Samsung Engineering Co., Ltd., Gangdong-gu, Seoul (KR)

(72) Inventors: Byung Chul YOO, Seoul (KR); Hyeon Gi BAEK, Seoul (KR); Hyun Il LEE, Seoul (KR); Yong Duk PARK, Seoul (KR); Ki Yong JEONG, Seoul (KR); Jae Eun KIM, Seoul (KR); Syung Houn BAE, Seoul (KR)

(21) Appl. No.: 18/266,122

(22) PCT Filed: Sep. 8, 2022
(86) PCT No.: PCT/KR2022/013566

§ 371 Date: Jun. 8, 2023

(30) Foreign Application Priority Data
Jul. 8, 2022 (KR) 10-2022-0084497

(51) Int. Cl. G06Q 10/0631; G06Q 50/08

(52) U.S. Cl. CPC G06Q 10/06314; G06Q 10/06313; G06Q 10/06316; G06Q 50/08

(57) ABSTRACT

Disclosed is a method and system for automatic establishment of an optimal schedule for a construction project. The disclosed method of automatic establishment of an optimal schedule for a construction project is a computer-implemented method of automatic establishment of an optimal schedule for a construction project, the method including: providing project data, standardized schedule data, and characteristic data (S10); generating project schedule data by combining the project data, the standardized schedule data, and the characteristic data (S20); and deriving an optimal project schedule by processing the project schedule data through a scheduling optimization algorithm (S30).

### TECHNICAL FIELD

Disclosed are a method and system for automatic establishment of an optimal schedule for a construction project. In particular, disclosed are the method and system for automatic establishment of an optimal schedule for a construction project, which can establish optimal schedules through metaheuristic-based scheduling algorithms by combining project data, characteristic information, and standardized schedule data.

### BACKGROUND ART

Conventionally, the majority of the step of establishing an optimal schedule for a construction project was manually done by a project scheduler.

In particular, from the relevant departments, a project scheduler receives project data required for scheduling in non-standard format, and after reviewing the received project data, manually creates a list of activities.

Then, using a scheduling tool (Primavera 6, Excel, or MS Project, etc.), durations are assigned to those created activities and relations are created.

A project schedule is a network schedule and must have all activities connected in predecessor and successor relationships. Accordingly, by referring to activity information, a project scheduler connects at least one preceding activity and one succeeding activity to each of all activities.

Then, with start dates and finish dates of all activities calculated by the scheduling tool, the project scheduler manually modifies activity durations and relationships between activities, to create a desired schedule.

However, this conventional scheduling step heavily relies on the project scheduler's personal experience, and since there is no criteria to evaluate scheduling results, different scheduling results may be derived even with the same conditions. Also, in such a conventional step, the project scheduler is required to manually and repeatedly perform the modification and evaluation of durations and relations. During this step, since all activities are connected in predecessor-successor relationships, modifying a particular activity inevitably causes a cascade of changes on all the subsequent activities, which is extremely difficult for a human to manage.

### DISCLOSURE OF INVENTION

### Technical Problem

One embodiment of the present invention provides a method of automatic establishment of an optimal schedule for a construction project, which can establish an optimal schedule through a metaheuristic-based scheduling algorithm by combining project data, characteristic information, and standardized schedule data.

Another embodiment of the present invention provides a system for automatic establishment of an optimal schedule for a construction project, which can establish an optimal schedule through a metaheuristic-based scheduling algorithm by combining project data, characteristic information, and standardized schedule data.

### Solution to Problem

According to one aspect of the present invention,
provided is a computer-implemented method of automatic establishment of an optimal schedule for a construction project, the method including:
providing project data, standardized schedule data, and characteristic data (S10);
creating project schedule data by combining the project data, the standardized schedule data, and the characteristic data (S20); and
deriving an optimal project schedule by processing the project schedule data through a scheduling optimization algorithm (S30).

The project data may include drawing information, material information, quantity information, manpower information, a standard library of the project, or a combination thereof.

The standardized schedule data may include standard activities, standard durations, standard relations, or a combination thereof.

The characteristic data may include an area, a calendar, a milestone, a work breakdown structure, or a combination thereof.

The project schedule data may include actual activities, actual durations, actual relations, or a combination thereof, each reflecting the project information.

The scheduling optimization algorithm may include a milestone and critical path scheduling sub-algorithm and a loading optimization sub-algorithm.

The milestone and critical path scheduling sub-algorithm may include a schedule data pre-review step, a major milestone target date compliance probability review step, a major milestone driving path selection step, and a critical path selection step.

The schedule data pre-review step may be a step of checking on whether relations are closed and whether it is possible to comply with a finish milestone date.

The major milestone target date compliance probability review step may include the following sub-steps: arranging all activities consecutively in a direction from finish milestone to start milestone of the project by using standard durations and standard relations of the activities; and adjusting the activities sequentially in a direction from the start milestone to the finish milestone of the project with the aim of complying with the major milestone target date.

The adjustment of the activities may be achieved by an equal adjustment and a fine adjustment, wherein the equal adjustment adjusts the durations and lags of all activities in a path by an equal proportion, and the fine adjustment makes an individual adjustment to a duration, lag, relation, or a combination thereof, of an individual activity in a path.

The major milestone driving path selection step may include the following sub-steps: generating a plurality of paths by modifying durations, relations, or a combination thereof of the activities, with respect to all milestones between, but not including a start milestone and a finish milestone; and from among paths generated by applying durations and relations of activities as reference values, selecting a path having the longest duration as a driving path and excluding the remaining paths from the driving path.

The critical path selection step may include the following sub-steps: generating a plurality of paths by modifying a duration, a relation or a combination thereof of an activity, with respect to the finish milestone, wherein an activity pre-specified by a user is included in each of the paths; and from among the plurality of paths, selecting a critical path according to the following priorities (1) to (3):
(1) First priority: the path in which the greatest number of the user-specified activities are included,
(2) Second priority: if a plurality of first priority paths exist, the longest path when the duration and relation are reference values, and
(3) Third priority: if a plurality of second priority paths exist, the path having the largest number of activities.

The loading optimization sub-algorithm may include: adjusting activity loading; quantitatively evaluating the activity loading; deciding whether a quantitative evaluation result is superior to an optimal solution; storing the quantitative evaluation result as an optimal solution; deciding whether an optimization termination condition is met; and terminating scheduling optimization.

The adjustment of activity loading may be performed through rearrangement of activities by discipline.

The loading optimization sub-algorithm may repeatedly perform a unit execution cycle consisting of a forward optimization and a backward optimization, wherein the forward optimization may perform optimization in a reverse order of disciplines from a final discipline to a start discipline, by rearranging activities to the later time points (i.e., the time points later the time points of activities before being rearranged) that a total score can be increased, and wherein the backward optimization may perform optimization in a forward direction of disciplines from the start discipline to the final discipline, by rearranging activities to the previous time points (i.e., the time points earlier than the time points of activities before being rearranged) that a total score can be increased.

The forward optimization and the backward optimization may each include a partial interval optimization and a total interval optimization, wherein the partial interval optimization may refer to a step of causing a small number of activities temporally spaced apart from an activity cluster to be temporally close to the activity cluster, and the total interval optimization may refer to a step of performing optimization on all the activities of a discipline.

The quantitative evaluation of activity loading may include the following sub-steps: calculating a total score by combining a float-based schedule score, a milestone-based schedule score, a critical path-based schedule score, a manhour leveling-based schedule score, and a quantity leveling-based schedule score, wherein the float-based schedule score may be calculated by multiplying a first point calculated according to Equation 1 by a corresponding weight factor, the milestone-based schedule score may be calculated by multiplying a second point calculated according to Equation 2 by a corresponding weight factor, and the critical path-based schedule score may be calculated by multiplying a third point calculated according to Equation 3 by a corresponding weight factor.

First point (%)=(1−the number of activities having a total float of 200 days or more/the total number of activities)×100 [Equation 1]

Second point (%)=the number of the user-specified milestones on schedule/the total number of the user-specified milestones×100 [Equation 2]

Third point (%)=the number of the reference activities in the critical path/the number of the reference activities for establishing the critical path×100 [Equation 3].

The manhour leveling-based schedule score and the quantity leveling-based schedule score may be each calculated by combining a target compliance rate-based schedule score, a reverse-based schedule score, and a peak over-based schedule score, wherein when a duration from the start date of the earliest activity to the finish date of the latest activity among activities included in a corresponding discipline is evenly divided into a plurality of intervals, the target compliance rate-based schedule score, the reverse-based schedule score, and the peak over-based schedule score may be each calculated based on a corresponding weight factor and a point evaluated for each interval, wherein the target compliance rate-based schedule score may be calculated by multiplying an average value of fourth points calculated according to Equation 4 for each interval by a corresponding weight factor, and the reverse-based schedule score and the peak over-based schedule score may be each calculated by multiplying the sum of scores of all non-reverse intervals and all reverse intervals by a corresponding weight factor.

Fourth Point (%)=The smaller of the target value and the result value/The larger of the target value and the result value×100 [Equation 4].

The decision on whether the quantitative evaluation result is superior to the optimal solution may be immediately followed by the storing of the quantitative evaluation result as the optimal solution if the decision is ‘Yes’, and may be immediately followed by the adjustment of activity loading if the decision is ‘No’.

The decision on whether the optimization termination condition is met may be immediately followed by the termination of scheduling optimization if the decision is ‘Yes’, and may be immediately followed by the adjustment of activity loading if the decision is ‘No’.

The optimization termination conditions may be to satisfy a maximum execution cycle or a maximum duration.

According to another aspect of the present invention,
provided is a system for automatic establishment of an optimal schedule for a construction project, the system being configured to execute the above-described method of automatic establishment of an optimal schedule for a construction project, and the system including:
a standard data version management module; and
a project schedule version management module.

The standard data version management module may include a standard data management module, wherein the standard data management module may be configured to manage information of standard milestones, information of standard activities, standard durations, standard relations, or a combination thereof.

The standard milestones may be classified as a start type or a finish type.

The standard milestones may include an engineering standard milestone, a procurement standard milestone, a construction standard milestone, or a combination thereof, wherein the standard activities may include an engineering standard activity, a procurement standard activity, a construction standard activity, or a combination thereof, the standard durations may include an engineering standard duration, a procurement standard duration, a construction standard duration, or a combination thereof, and the standard relations may include an engineering standard relation, a procurement standard relation, a construction standard relation, or a combination thereof.

The construction standard activity may be classified as deliverable type or non-deliverable type depending on the existence of engineering output, and may be defined for each engineering stage (i.e., engineering working procedure) interlocked with the engineering standard milestone, and the engineering standard duration may be determined according to the engineering standard milestone.

The procurement standard activity may be classified as item or bulk, depending on the type of equipment or material, and may be defined for each sub-procurement stage (i.e., sub-procurement working procedure) that exists for each equipment or material type, wherein the procurement standard duration may be defined according to equipment or material type for each procurement standard stage (i.e., procurement standard working procedure) registered.

The construction standard activity may be defined according to work classification criteria, and the construction standard duration may be divided into a plurality of intervals according to the size of quantity for each activity, and may be defined for each interval.

The standard duration may be configured in the form of minimum value/reference value/maximum value.

The standard relation may define a predecessor-successor relation between two standard activities and may be configured in the form of a relation type and lag, wherein the relation type may include Finish-to-Start (FS), Start-to-Star (SS), Finish-to-Finish (FF), or a combination thereof.

The project schedule version management module may include a project information registration module, a scheduling module, and a result analysis module, wherein the project information registration module may be configured to register a work breakdown structure, a calendar, milestone planning, resource planning, a project data interface, or a combination thereof, the scheduling module may be configured to perform activity creation, duration generation, relation generation, and schedule optimization, and the result analysis module may be configured to perform milestone date and loading result check, quantitative evaluation result analysis, and data transmission to a scheduling program.

### Advantageous Effects of Invention

The method and system for automatic establishment of an optimal schedule for a construction project according to an embodiment of the present invention have the following advantages:
(1) reducing man-hour (M/H) for project/proposal data collection and schedule establishment.
(2) as for EPC (engineering procurement construction) projects, all projects contain inherent characteristics such as a project's execution scope, area, client requests, and the like, and a project schedule should be prepared reflecting all of such inherent characteristics of the project. The method and system of the present invention create activities based on EPC project data, and by utilizing detailed information, automatically generate specific durations and relations for each activity. Accordingly, unlike methods which proportionally increase or decrease the entire standardized project schedule as a whole, the method and system of the present invention can establish a detailed schedule specific to a corresponding project in such a way that the scope, constrains, characteristics, and the like of the project are reflected for each activity.
(3) Since the method and system of the present invention create activity lists, assign durations, and form relations based on logics and criteria defined in the standard data management module, uniform quality across project scheduling results can be ensured. In addition, by establishing criteria for quantitative evaluation of project schedules and establishing a project schedule by utilizing the criteria, scheduling results can be quantified and evaluated objectively.
(4) The method and system of the present invention automatically generate a project schedule by reflecting project characteristics and strategy based on project data and standardized schedule data. Since this enables a quick and easy schedule simulation, a project schedule can be simulated under various conditions, by having taken into consideration a lot of unascertained information, execution uncertainty, etc. at the initial stage of a project.

### BRIEF DESCRIPTION OF DRAWINGS

FIG. 1 illustrates a method and system for automatic establishment of an optimal schedule for a construction project according to an embodiment of the present invention.

FIG. 2 illustrates FIG. 1 in greater detail.

FIG. 3 is a flowchart showing a scheduling optimization algorithm.

FIG. 4 illustrates a method of evaluating an appropriate project duration.

FIG. 5 illustrates a method of applying equal adjustment and fine adjustment to durations and lags of activities.

FIG. 6 illustrates a driving path of a particular milestone.

FIG. 7 illustrates a driving path and a critical path.

FIG. 8 shows an arrangement of activities according to cycle and discipline for loading optimization.

FIG. 9 illustrates a loading optimization method within a discipline.

FIG. 10 shows schedule score calculation criteria.

FIG. 11 shows loading score calculation criteria.

FIG. 12 is for explaining the meaning of duration, Reverse, and Peak Over described in FIG. 11.

FIG. 13 shows a diagram of a system for automatic establishment of an optimal schedule for a construction project according to an embodiment of the present invention.

FIG. 14 shows a list of engineering standard durations according to engineering standard activity.

FIG. 15 shows a list of procurement standard durations according to equipment or material type and standard step.

FIG. 16 shows a list of construction standard durations according to construction standard activity.

FIG. 17 shows a list of standard relations defined between standard activities.

FIG. 18 shows a structure and operation scheme of a standard duration.

FIG. 19 shows a configuration and operation scheme of a standard relation.

FIG. 20 shows a milestone input screen.

FIG. 21 shows a resource planning conditions input screen.

FIG. 22 illustrates an operation process of a method and system for automatic establishment of an optimal schedule for a construction project according to embodiments of the present invention.

FIG. 23 shows a project activity generation scene.

FIG. 24 illustrates a generation scheme of a project activity.

FIG. 25 illustrates a method of generating attribute information of an engineering activity.

FIG. 26 illustrates a method of generating relations by each step.

FIG. 27 shows predecessor-successor connection conditions between 2-step objects.

FIG. 28 shows a final output project schedule.

FIG. 29 shows a milestone result analysis screen.

FIG. 30 shows a driving path screen.

FIG. 31 shows an overall evaluation result screen.

FIG. 32 shows a discipline evaluation result screen.

### MODE FOR THE INVENTION

Hereinafter, a method and system of automatic establishment of an optimal schedule for a construction project according to an embodiment of the present invention will be described in detail with reference to the accompanied drawings.

The term “activity” as used herein refers to a unit work required to execute a project.

Also, the term “area” as used herein refers to a portion obtained by physically dividing a construction site of a project.

Also, the term “calendar” as used herein refers to a system designating working days.

Also, the term “milestone” as used herein refers to a point (date) that requires important management in a project schedule.

Also, the term “major milestone” as used herein refers to a milestone having a target point (date) designated according to a project's contract conditions and project execution strategy. For example, the major milestone may include a project start milestone, a project finish milestone, a construction site opening milestone, a construction finish milestone, a startup milestone according to the project contract conditions.

Further, the term “work breakdown structure (WBS)” as used herein refers to a hierarchical system in which a series of works performed to obtain a final product are constructed in a family tree form, and it also refers to a construction scheme of individual work items. For example, the WBS may have engineering/procurement/construction as Level 1, discipline unit as Level 2, and area as Level 3, and activity at Level 4.

The term “duration” as used herein refers to a duration between an activity's start date to its finish date.

The term “relation” as used herein refers to a relation between preceding and succeeding activities.

The term “loading” as used herein refers to a percentage of work amount assigned per unit duration, and in this specification, it is divided into manpower loading and quantity loading.

The term “discipline” as used herein refers to a project execution department.

The term “standard” as used herein refers to a definition of how a project is generally carried out regardless of project classification, and “standard activity” refers to a standardized task, “standard duration” refers to a standardized duration required for each standard activity, and “standard relation” refers to a standardized predecessor-successor relation between standard activities, each of which being standardized by analyzing project performance information that was actually carried out.

The term “driving path” as used herein refers to a path of activities between a start milestone and a finish milestone wherein the milestones between, but excluding, the start milestone and the finish milestone, are each individually scheduled.

The term “critical path” as used herein refers to a path of activities that determines the schedule of a finish milestone, and it also refers to a path of activities that interferes with a project finish milestone if delayed.

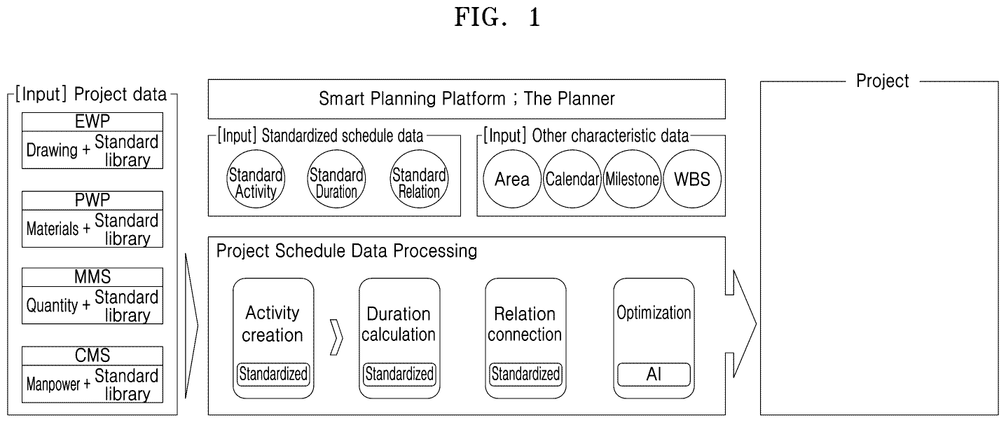

First, with reference to FIG. 1 to FIG. 12, a method of automatic establishment of an optimal schedule for a construction project according to an embodiment of the present invention will be described in detail.

The method of automatic establishment of an optimal schedule for a construction project according to an embodiment of the present invention may be implemented by a computer.

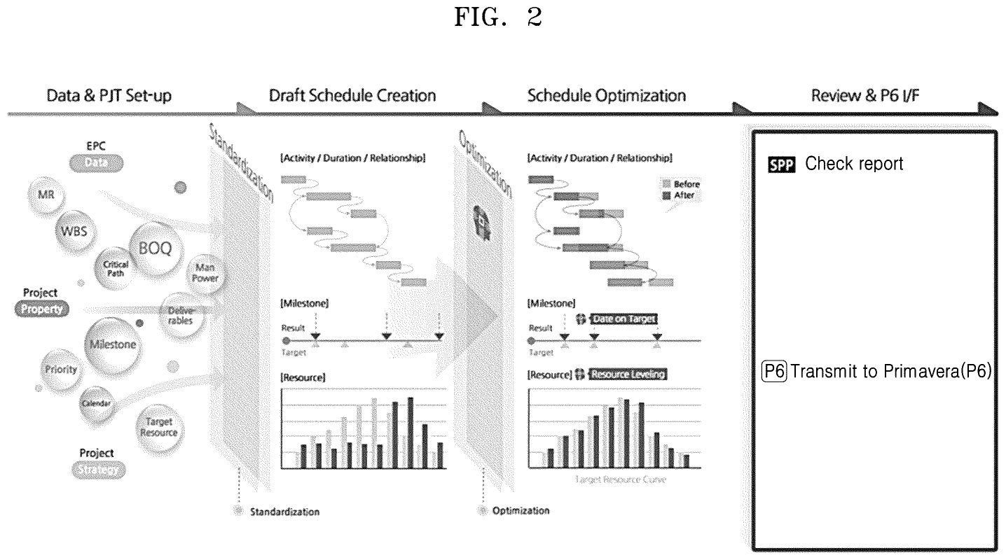

FIG. 1 illustrates a method and system for automatic establishment of an optimal schedule for a construction project according to an embodiment of the present invention, and FIG. 2 shows FIG. 1 in greater detail.

As illustrated in FIG. 1 and FIG. 2, the method of automatic establishment of an optimal schedule for a construction project may include: providing project data, standardized schedule data, and characteristic data (S10); creating project schedule data by combining the project data, the standardized schedule data, and the characteristic data (S20); and deriving an optimal project schedule by processing the project schedule data through a scheduling optimization algorithm (S30).

In the step (S10), the project data may include drawing information, material information, quantity information, manpower information, a standard library of the project, or a combination thereof.

The drawing information may include an entire list of drawings.

The material information may include types and/or names of materials.

The quantity information may include a construction quantity, which is a quantity of work done by human or machinery.

The manpower information may include the size of manpower required to execute construction.

The standard library may include individual standard activity information, for drawings, materials, quantities, and manpower. For example, the drawing information may include an entire list of drawings with respect to a project scope, and each drawing list may contain standard activity information according to drawing classification.

In addition, in the step (S10), the standardized schedule data may include standard activities, standard durations, standard relations, or a combination hereof.

In the step (S20), each of the drawing information, material information, quantity information, and manpower information of the project may be combined with the standardized schedule data and other characteristic data to thereby generate the project schedule data in the form of actual activities, actual durations, actual relations, or a combination thereof, each of which reflecting project information.

Therefore, in the step (20), it is possible to generate project schedule data in a network form where all activities from the project's start milestone to its finish milestone are connected as predecessors and successors, by utilizing schedule data which exist in individual activity unit, such as an activity list, duration information for each activity, and predecessor-successor relation information for each activity.

The project schedule data may include a duration and relation for each activity in a modifiable range, and the scheduling optimization algorithm may repeatedly perform activity modifications and quantitative evaluations of the overall schedule on the basis of the project schedule data to thereby derive an optimal project schedule that complies with a major milestone of a corresponding project and optimizes loading.

In addition, the method of automatic establishment of an optimal schedule for a construction project may generate a project schedule that reflects the project scope and schedule, the project's execution strategy, and a client's requests. In particular, the method of automatic establishment of an optimal schedule for a construction project does not stop at simply establishing a standard schedule and applying a proportional increase/decrease according to the project's schedule, but further combines project data with standardized schedule data to generate schedule data specific to the project, and based on the project's execution strategy, establishes an optimized scheduling result. In particular, the establishing of a schedule may be done in a top-down manner. More specifically, when a project execution plan is inputted to major milestone dates, the method of the present invention may establish detailed schedules of activities, with the aim of complying with the milestone dates.

The schedule optimization scheme of the scheduling optimization algorithm is to derive an optimal solution by repeatedly performing activity modifications and evaluations of the overall schedule. To this end, minimum/reference/maximum values are assigned to an activity duration, and also to a relation, up to 3 modifiable values are assigned. Accordingly, the meta heuristics-based scheduling optimization algorithm may derive an optimal solution by repeatedly performing, within a modifiable range of each activity, activity modifications and quantitative evaluations of the overall schedule.

Subsequent to the step (S30), the method of automatic establishment of an optimal schedule for a construction project may further include a step of analyzing the optimal project schedule derived in the step (S30) to provide item-based quantitative evaluation results, discipline-based loading results, milestone date results, and a driving path of activities determining the same, and the like.

In addition, the step (S40) may transmit to a scheduling tool (e.g., Primavera P6) not only a list of activities and activity durations and relations, but also all data constituting a schedule, such as manpower, quantity, work breakdown structure (WBS), and the like.

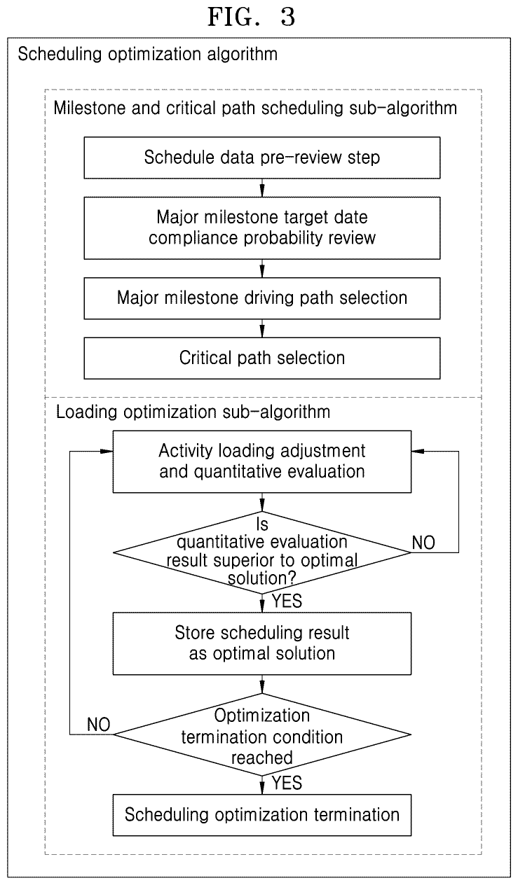

FIG. 3 is a flowchart showing a scheduling optimization algorithm.

As illustrated in FIG. 3, the scheduling optimization algorithm may include a milestone and critical path scheduling sub-algorithm and a loading optimization sub-algorithm.

The milestone and critical path scheduling sub-algorithm may perform the work of selecting activities which determine the schedule of a major milestone in terms of the date.

In particular, by modifying the duration and/or relation of an activity while the target date of the major milestone is fixed, the milestone and critical path scheduling sub-algorithm evaluates whether or not the target date of a major milestone is met. Through this step, according to major milestone, a driving path of activities determining the schedule is determined. Since the method of the present invention is a top-down method that establishes the detailed activity schedule based on the target date of a major milestone, it is possible to prevent the date of the major milestone from changing by fixing the driving path.

More specifically, the milestone and critical path scheduling sub-algorithm may include a schedule data pre-review step, a major milestone target date compliance probability review step, a major milestone driving path selection step, and a critical path selection step.

The schedule data pre-review step may be a step of checking on whether relations are closed (referring to a state in which the successor connections of activities proceed sequentially and then returns to the first preceding activity, i.e., A→B→C→A, where an endless loop will occur) and whether it is possible to comply with a finish milestone date. That is, since complying with the finish milestone date of the project is one of the most important targets in establishing a project schedule, before establishing the detailed schedule, first check on whether the finish milestone may be complied with.

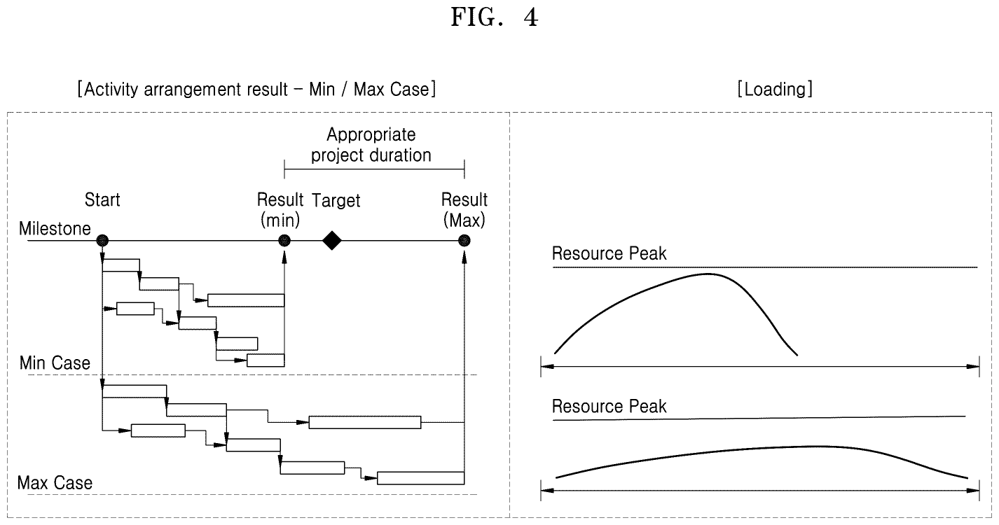

In particular as illustrated in FIG. 4 depicting a method of evaluating a project appropriate duration, an earliest possible date (Min Case) and a latest possible date for a finish milestone are each calculated by utilizing all ranges of durations, relations, and lags of all activities, and whether the target date is complied with may be checked by checking on whether the target date of the finish milestone exists between the earliest possible date and the latest possible date calculated above. Here, when activities are arranged according to the earliest possible date, as illustrated with Min Case in FIG. 4, a number of activities may be excessively overlapped at a particular point in time, thus causing an excessive loading. However, since an actual project execution cannot be planned with an unlimited supply of resources, a maximum loading (Resource Peak) is set to a level where resources are allowable, and at a level that does not exceed this, the arrangement of activities may be adjusted and the fastest milestone date may be calculated. The fastest date and the latest date thus calculated may be utilized to estimate an appropriate project duration. Not being able to comply with the target date of the finish milestone means that the corresponding project schedule data fails to comply with a given project execution duration. In such a case, the method of the present invention terminates scheduling and provides a user with the possible earliest date and possible latest date of the finish milestone.

The major milestone target date compliance probability review step may include the following sub-steps: arranging all activities consecutively in a direction from finish milestone to start milestone of the project by using standard durations and standard relations of the activities; and adjusting the activities sequentially in a direction from the start milestone to the finish milestone of the project with the aim of complying with the major milestone target date. In particular, all the activities are arranged sequentially in the direction from the finish milestone to the start milestone of a corresponding project. Here, for the duration and relation of an activity, their respective reference values are used. Since the most common execution manner was defined as the reference value when executing the corresponding activity, to reflect this, the activity is first arranged using the reference value and then this activity arrangement is adjusted in a later step. Once the arrangement of activities is complete, all activities must have at least one preceding activity and one succeeding activity, and a path connecting the activities is formed from the start milestone to the finish milestone of the corresponding project, Subsequently, activities are adjusted with aim to comply with the target dates of milestones sequentially in a forward direction from the start milestone to the finish milestone. The reason the preceding activities are sequentially adjusted first is that since all activities are connected in predecessor-successor relations, any change in the preceding activity will cause a change to the dates of all the succeeding activities connected thereto. In addition, as the duration and relation of an activity depart further from the reference values and approach their respective minimum value or maximum value, risks involved in executing the corresponding activity are deemed to increase. Accordingly, the scheduling optimization algorithm prioritizes applying reference values to the duration and relation of an activity, and to prevent the modifications of duration and relation from being concentrated on a specific activity, it may be designed in such a way that it adjusts for the entire activities and then adjusts a specific activity when necessary.

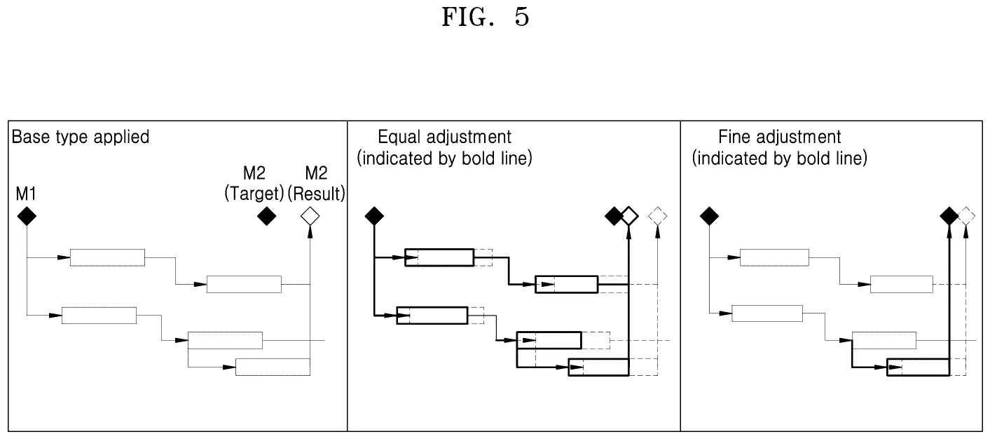

The adjustment of activities, as illustrated in FIG. 5, may be achieved by an equal adjustment which adjusts durations and lags of all activities in a path by an equal proportion, and by a fine adjustment which individually adjusts the duration, lags, relations or a combination thereof for each activity in the path. In particular, the equal adjustment involves adjusting the durations and lags of activities on a driving path that determine the date of a particular milestone by an equal proportion, so to derive a date of the most approximate value compared to the optimal value. The date of a particular milestone is derived by repeatedly increasing or decreasing by 1% from the base of duration and lag, and an increased or decreased duration of less than 1 day is not reflected. The fine adjustment involves increasing/decreasing a duration, increasing/decreasing a lag, and/or changing the relation type, according to an activity, so as to accurately comply with the target date of the milestone.

In FIG. 5, diamond indicates milestones, M2 (target) indicates the target date of M2, and M2 (result) indicates the date of M2 resulting from the activity arrangement. Accordingly, FIG. 5 illustrates performing activity adjustments so as to allow M2 (result) to approach M2 (target). In particular, in the equal adjustment in FIG. 5, the result of equally reducing the durations and lags of all the activities is indicated by bold solid line. In addition, the result of equally reducing the duration and lag of a particular activity in the fine adjustment performed subsequent to the equal adjustment is indicated by bold solid line.

Referring back to FIG. 3, since the scheduling optimization algorithm prioritizes compliance with a milestone target date, the operation of establishing the path of activities that determine the date of each milestone (that is, a driving path) is necessary. Activities determined as a driving path are later excluded from the adjustment of activity arrangement in the loading optimization sub-algorithm.

The major milestone driving path selection step may include the following sub-steps: generating a plurality of paths by modifying durations, relations, or a combination thereof of the activities, with respect to all milestones between, but not including a start milestone and a finish milestone; and from among paths generated by applying durations and relations of activities as reference values, selecting a path having the longest duration as a driving path and excluding the remaining paths from the driving path by creating a float. Here, floats are created in a manner that does not impact other major milestone dates. In particular, as many driving paths are generated as possible. The reason for generating as many driving paths as possible is that in the event that a modification is made to the preceding activity to accommodate the succeeding milestone date, and even if a change occurs to a particular driving path during this step, the corresponding milestone date can avoid being impacted by the change, through other driving paths. In the end, it is ensured that there exists one driving path for each of all milestones.

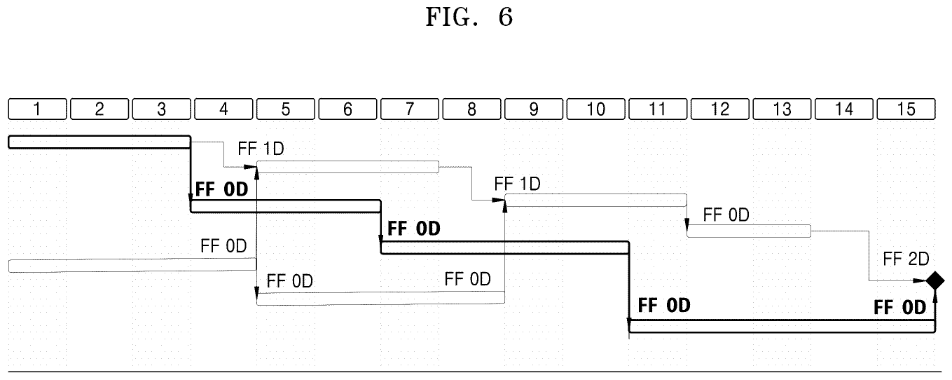

FIG. 6 shows a driving path for a particular milestone.

Next, the step of selecting a driving path for a finish milestone, that is, the critical path for the overall schedule, follows. This step is similar to the step of selecting the driving path described above. However, in this step, a logic that considers user-specified activities to be included in the critical path additionally works.

The critical path refers to a path of activities that determines a finish date of a project, and since a change made to the date of an activity in the corresponding path directly impacts the finish date of the project, the critical path is generally recognized as an object of intensive management. In addition, depending on the environment of project execution, it may become necessary to reflect a particular activity in the critical path, or it may be necessary to artificially configure a critical path and reflect it in a project execution strategy.

The critical path selection step may include the following sub-steps: generating a plurality of paths by modifying a duration, a relation or a combination thereof of an activity, with respect to the finish milestone, wherein an activity pre-specified by a user is included in each of the paths; and from among the plurality of paths, selecting a critical path according to the following priorities (1) to (3):
(1) First priority: the path in which the greatest number of the user-specified activities are included,
(2) Second priority: if a plurality of first priority paths exist, the longest path when the duration and relation are reference values, and
(3) Third priority: if a plurality of second priority paths exist, the path having the largest number of activities.

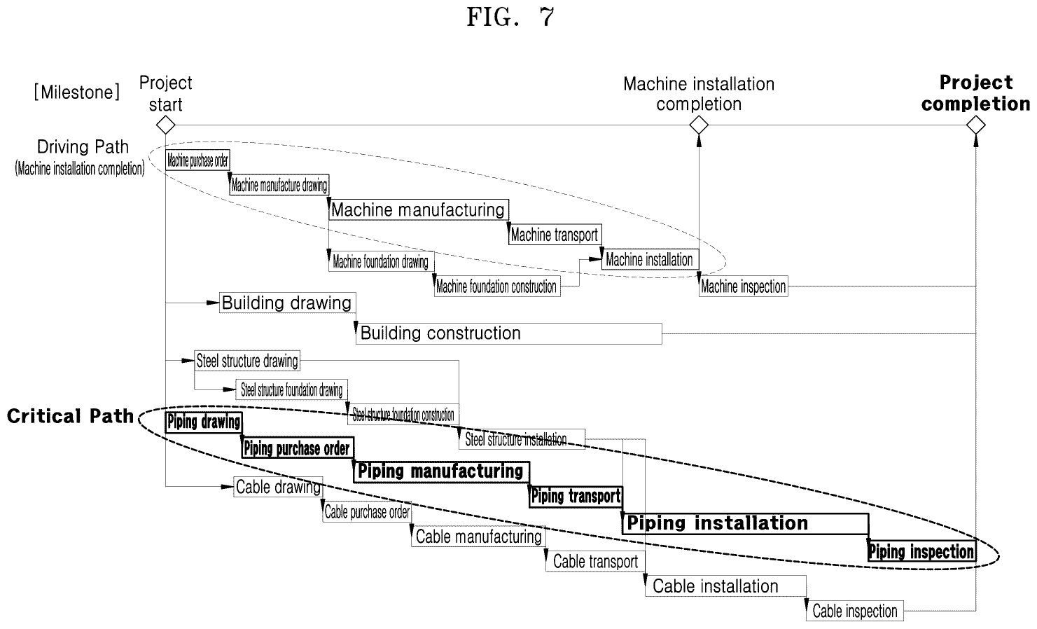

FIG. 7 illustrates a driving path and a critical path.

As illustrated in FIG. 7, the driving path for a milestone “Machine installation completion” consists of activities within a thin dotted ellipse from machine purchase order to machine installation, and the critical path for a milestone “Project completion” consists of activities within a bold dotted ellipse from pipe drawing to pipe inspection. The method of the present invention, by selecting a driving path and a critical path, has an effect of preferentially establishing a target date of a major milestone from a scheduling point of view. In addition, since it is possible to know activities that determine a project schedule from the method of the present invention, the method of the present invention can easily adjust the entire project schedule by adjusting the corresponding activities, and helps to select a target activity that requires intensive management in the project execution stage.

In the previous step, through the milestone and critical path scheduling sub-algorithm, the schedule that complies with the dates of user-specified major milestones is established. In this step, through the loading optimization sub-algorithm, activities are rearranged to prevent resources allocated to activities from overloading and thus creating an excessive load during actual execution of the activities.

Since a modification made to the driving paths and critical path established in the previous step may cause a change to milestone dates, loading optimization in this step is performed while excluding the activities on the corresponding driving path and the critical path. This loading optimization step is a step for rearranging activities for each discipline to compute loading results and quantitatively comparing them to the target loading to find the best activity arrangement.

Referring back to FIG. 3, the loading optimization sub-algorithm may perform the task of arranging activities to comply with a resource distribution objective in terms of resources. This allows a schedule to be fixed in terms of dates so as to meet the target dates registered by a user through the scheduling step, and through the optimization step, also allows optimal distribution of resources within a range that does not impact the schedule.

In particular, the loading optimization sub-algorithm may perform repeated simulations of deriving a result approximate to a planned resource value through rearrangement of other activities excluding the activities included in the driving path.

More particularly, the loading optimization sub-algorithm may include adjusting activity loading; quantitatively evaluating the activity loading; deciding whether a quantitative evaluation result is superior to an optimal solution; storing the quantitative evaluation result as an optimal solution; deciding whether an optimization termination condition is met; and terminating scheduling optimization.

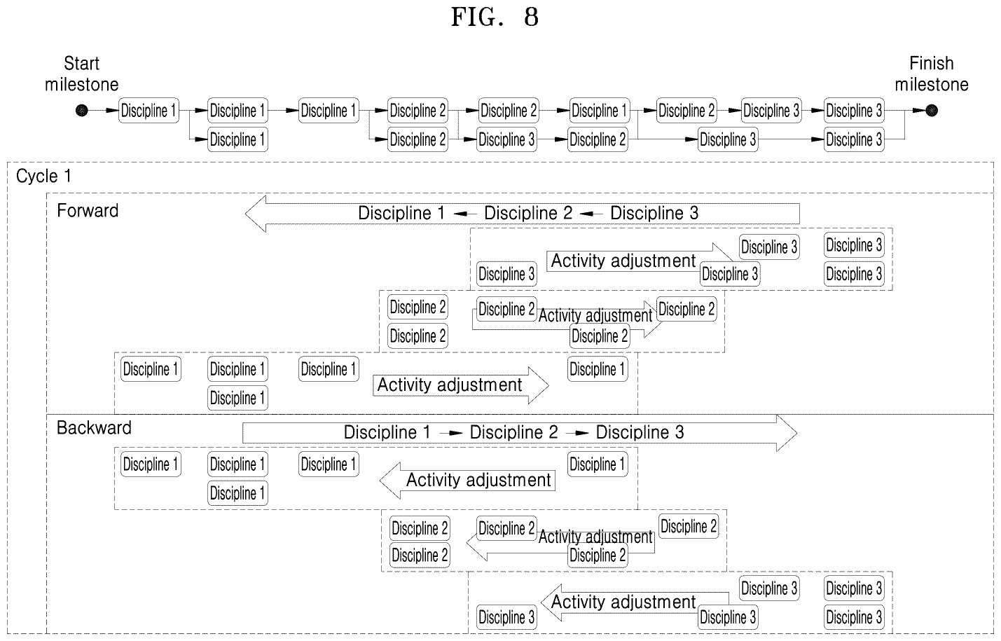

The loading optimization is performed for each execution cycle, and as illustrated in FIG. 8, separately for each unit discipline, the loading optimization is performed in the order of forward optimization and backward optimization. Repeating the forward optimization and backward optimization serves to prevent activities from being concentrated in any one particular interval and serves to allow activities to be evenly distributed in both directions.

In particular, the adjustment of the activity loading may be performed through activity rearrangement for each discipline.

The loading optimization sub algorithm may repeatedly perform a unit execution cycle consisting of a forward optimization and a backward optimization, wherein the forward optimization may perform optimization in a reverse order of disciplines from a final discipline to a start discipline, by rearranging activities to the later time points (i.e., the time points later the time points of activities before being rearranged) that a total score can be increased, and wherein the backward optimization may perform optimization in a forward direction of disciplines from the start discipline to the final discipline, by rearranging activities to the previous time points (i.e., the time points earlier than the time points of activities before being rearranged) that a total score can be increased. In particular, after sequentially rearranging activities for unit discipline, a score is calculated with respect to the total intervals and compared to the result of the previous execution cycle to decide whether to select the result of the current execution cycle. The result of the current execution cycle is selected if the score of the current execution cycle is higher than the score of the previous execution cycle, and if not, the result of the previous execution cycle is retained.

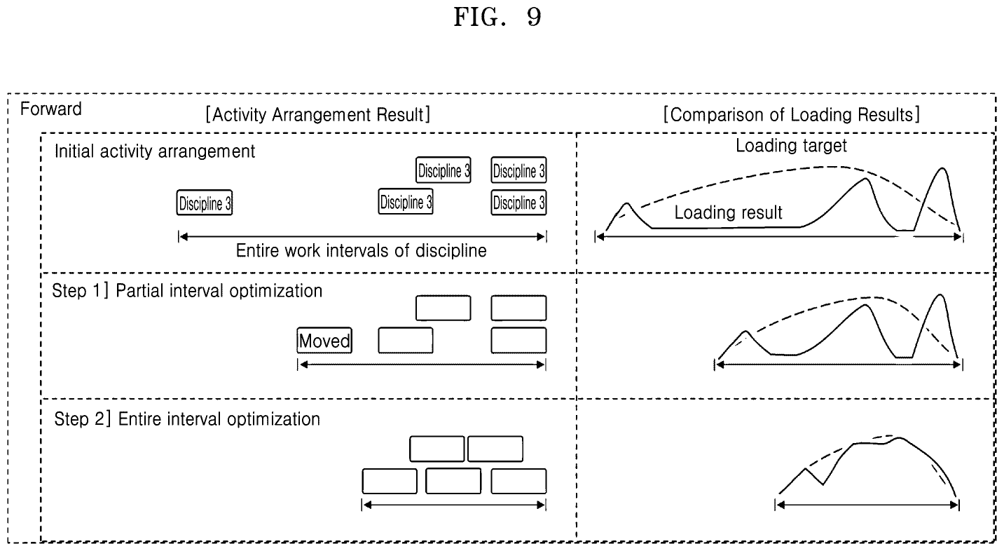

In particular, as shown in FIG. 9 illustrating the method of loading optimization within discipline, the forward optimization and the backward optimization may each include a partial interval optimization and an entire interval optimization, wherein the partial interval optimization may refer to a step of causing a small number of activities temporally spaced apart from an activity cluster to be temporally close to the activity cluster, and the entire interval optimization may refer to a step of performing optimization on all the activities of a discipline.

Next, after performing optimization within a discipline, a score for the overall schedule is calculated, and compared to the result of the previous execution cycle to decide whether to reflect the result of the current execution cycle.

The quantitative evaluation on the overall schedule is performed with accordance with the following 5 quantitative evaluation criteria, and the user may induce schedule establishment in an intended direction by adjusting a weight factor for each quantitative evaluation criterion.

This evaluation method is a method of technically evaluating the schedule result, and the following 5 items can be used as indicators for the loading optimization sub-algorithm to derive an optimal solution.

The 5 quantitative evaluation criteria include float, milestone, critical path, manhour leveling, and quantity leveling. Among these criteria, float, milestone and critical path are indicators to evaluate the quality of how well the schedule is made in terms of date, and man hour leveling and quantity leveling are indicators to evaluate the optimization of resource distribution.

The total float is the total slack period of the activity, and refers to the slack period that does not affect the schedule of the corresponding project even if the schedule of the corresponding activity is delayed. High total float may be understood as a sign that there is room in the schedule, but at the level of individual activity, there may be many instances such as unreasonable shortening of a schedule, or predecessor-successor relations being overlapped such as in start-to-start (SS), which may introduce risks associated with schedule compliance during actual project execution. On contrary, small total float indicates that there is room in individual activities' schedules and predecessor-successor relations, but other activities as well as a critical path may potentially cause schedule lags. In this context, in the method of the present invention, through actually executed project analysis and expert interviews, the case where the total float is 200 days is defined as the reference, and the total float-based compliance rate was established as the evaluation criterion for all activities.

Milestone date compliance rate indicates how many milestones, out of the total milestones assigned with target dates, have met their respective target dates. Critical path compliance rate evaluates how many pre-specified activities are included among the activities in the critical path.

As described above, the total float-based compliance rate, the milestone date compliance rate, and the critical path compliance rate is an evaluation indicator for schedule quality, such as how well the schedule establishment result meets the target schedule and how well it is organized, and the like.

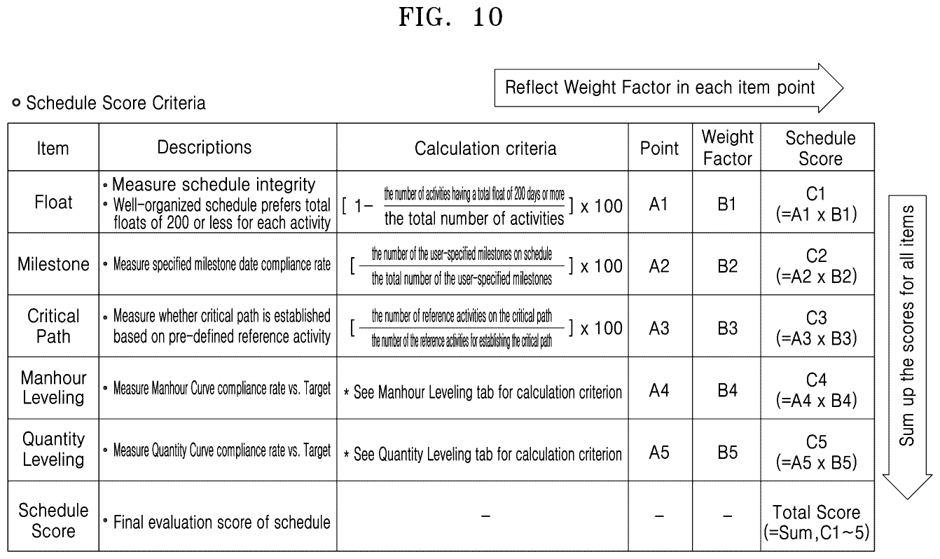

Referring to FIG. 10 showing schedule score calculation criteria, the quantitative evaluation of activity loading may include calculating a total score by combining a float-based schedule score, a milestone-based schedule score, a critical path-based schedule score, a manhour leveling-based schedule score, and a quantity leveling-based schedule score, wherein the float-based schedule score (C1) may be calculated by multiplying a first point (A1) calculated according to Equation 1 by a corresponding weight factor (B1), the milestone-based schedule score (C2) may be calculated by multiplying a second point (A2) calculated according to Equation 2 by a corresponding weight factor (B2), and the critical path-based schedule score (C3) may be calculated by multiplying a third point (A3) calculated according to Equation 3 by a corresponding weight factor (B3):

First point (%)=(1−the number of activities having a total float of 200 days or more/the total number of activities)×100 [Equation 1]

Second point (%)=the number of the user-specified milestones on schedule/the total number of the user-specified milestones×100 [Equation 2]

Third point (%)=the number of the reference activities in the critical path/the number of the reference activities for establishing the critical path×100 [Equation 3].

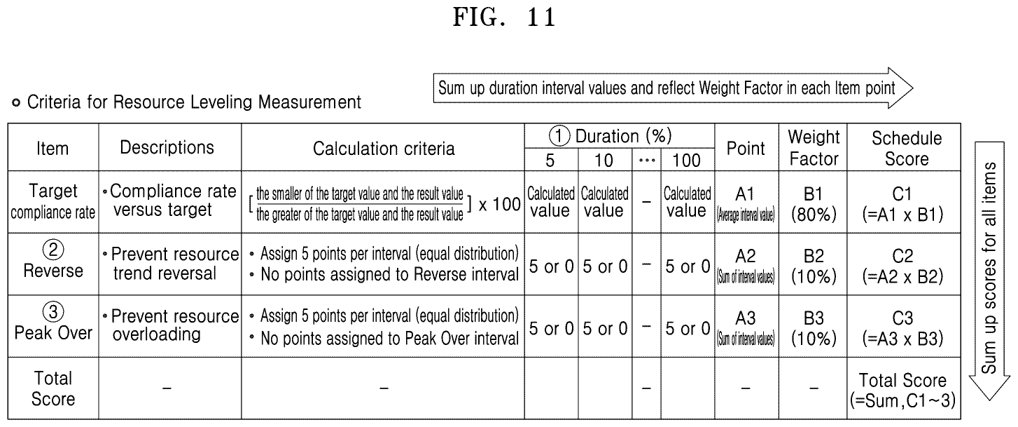

Next, referring to FIG. 11 showing loading score calculation criteria, the manhour leveling-based schedule score (C4) and the quantity leveling-based schedule score (C5) may be each calculated by combining a target compliance rate-based score (C1), a reverse-based schedule score (C2), and a peak over-based schedule score (C3). In addition, when a duration from a start date of the earliest activity to a finish date of the latest activity among activities included in a corresponding discipline is evenly divided into a plurality of intervals (for example, evenly into 20 sections), the target compliance rate-based score (C1), the reverse-based schedule score (C2), and the peak over-based schedule score (C3) may be each calculated based on a corresponding weight factor and a point evaluated for each interval. In addition, the target compliance rate-based schedule score (C1) may be calculated by multiplying an average value (A1) of fourth points calculated according to Equation 4 for each interval, by a corresponding weight factor (B1). In addition, the reverse-based schedule score (C2) and the peak over-based schedule score (C3) may be each calculated by multiplying the sum of scores of all non-reverse intervals (for example, 5 points per non-reverse interval) and scores of all reverse intervals (for example, 0 point per reverse interval) by a corresponding weight factor (B2 or B3).

Fourth Point (%)=The smaller of the target value and the result value/The larger of the target value and the result value×100 [Equation 4].

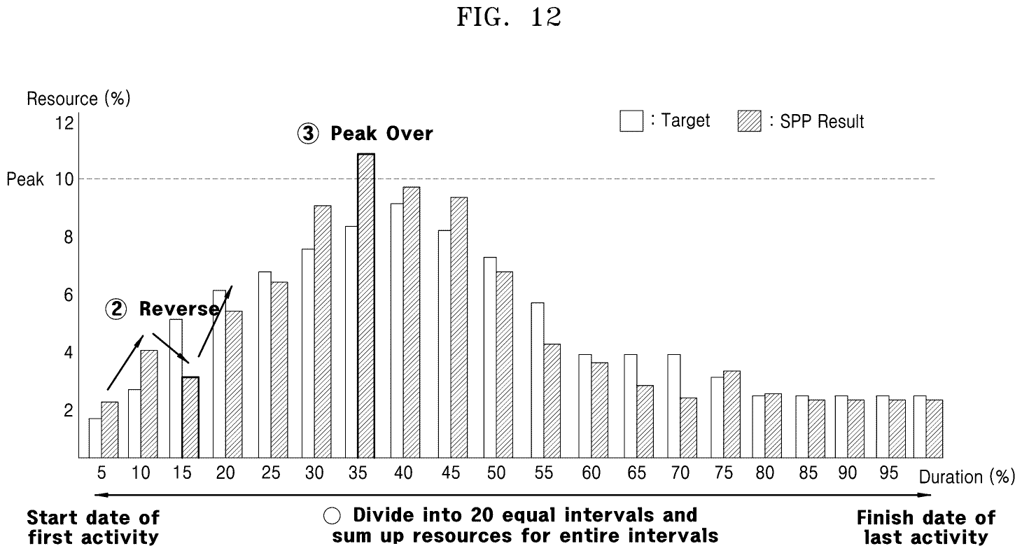

In particular, evaluations for manhour leveling and quantity leveling may be performed as illustrated in FIG. 11 and FIG. 12. That is, upon registering a target manhour and a target quantity for each discipline, the loading optimization sub-algorithm repeatedly performs simulation work to derive a result similar to a target. For example, among the activities included in the corresponding discipline, the duration from a start date of the earliest activity to a finish date of the latest activity is calculated, and this duration is evenly divided into 20 intervals (indicated by \textcircled{1} in FIG. 11), and target compliance rate, reverse (indicated by \textcircled{2} in FIG. 11), and peak over (indicated by \textcircled{3} in FIG. 11) are evaluated for each interval.

Target compliance rate is a value calculated as a percentage indicating how different a result value is from its target value.

Reverse is an indicator of trend continuity of man-hour and quantity planning. Generally, the man hour to mobilize project execution personnel and quantity to handle construction quantity tend to gradually increase from the beginning, and then decrease after hitting maximum values, and in order to quantitatively evaluate such trends, it is evaluated whether a trend change has occurred compared to the preceding interval.

Finally, Peak Over is an indicator that designates the maximum value of resources that can be established within one interval to prevent intensive overlapping of activities and evaluates whether the resource maximum is exceeded.

For example, the graph in FIG. 12 shows that in SPP Result in blue (that is, darker color), Reverse indicating a trend reversal has occurred in the intervals at 15% and 75% durations, and Peak Over has occurred in the interval at 35% duration.

Referring back to FIG. 3, the decision on whether the quantitative evaluation result is superior to the optimal solution may be immediately followed by the storing of the quantitative evaluation result as the optimal solution if the decision is ‘Yes’, and may be immediately followed by the adjustment of activity loading if the decision is ‘No’.

Referring back to FIG. 3, the decision on whether the optimization termination condition is met may be immediately followed by the termination of scheduling optimization if the decision is ‘Yes’, and may be immediately followed by the adjustment of activity loading if the decision is ‘No’.

The optimization termination conditions may be to satisfy a maximum execution cycle or a maximum duration. Once the optimization termination conditions are reached, the loading optimization sub-algorithm terminates the optimization.

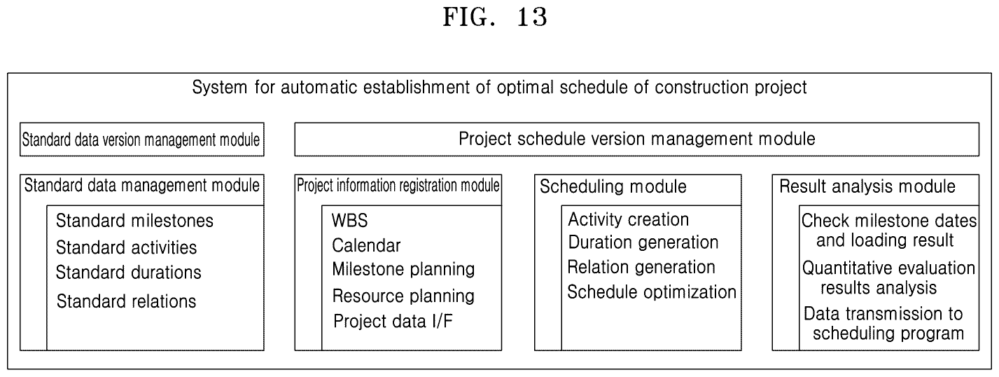

Hereinafter, a system for automatic establishment of an optimal schedule for a construction project according to an embodiment of the present invention will be described in greater detail with reference to FIG. 13 to FIG. 31.

According to one embodiment of the present invention, the system for automatic establishment of an optimal schedule for a construction project may be configured to execute the above-described method of automatic establishment of an optimal schedule for a construction project.

FIG. 13 is a configuration diagram for a system for automatic establishment of an optimal schedule for a construction project according to an embodiment of the present invention.

As illustrated in FIG. 13, the system for automatic establishment of an optimal schedule for a construction project according to an embodiment of the present invention includes a standard data version management module and a project schedule version management module.

The standard data version management module may include a standard data management module.

The standard data management module may be configured to manage standard milestone information, standard activity information, standard durations, standard relations, or a combination thereof.

The standard milestone information may include a list of standard milestones, whether or not each milestone is a major object to be managed, and standard dates, and the standard milestones may be classified as a start type or a finish type.

Table 1 shows a standard milestone configuration.

TABLE 1

| | Number of | Number of | Total number | |
|---|---|---|---|---|
| Discipline | Start Type | Finish Type | of Milestones | |
| Architecture (construction | 1 | 9 | 10 | 245 |
| discipline) | | | | |
| Civil | 12 | 13 | 25 | |
| Commissioning | 13 | 12 | 25 | |
| Common Temp. | 2 | 0 | 2 | |
| Construction Management | 1 | 4 | 5 | |
| Electrical | 7 | 17 | 24 | |
| Engineering Management | 0 | 2 | 2 | |
| Instrument | 5 | 19 | 24 | |
| Insulation | 2 | 4 | 6 | |
| Machinery | 3 | 8 | 11 | |
| Painting | 1 | 1 | 2 | |
| Piping | 13 | 31 | 44 | |
| Process | 1 | 8 | 9 | |
| Procurement Management | 2 | 3 | 5 | |
| Project Management | 2 | 19 | 21 | |
| Stationary | 2 | 11 | 13 | |
| Steel Structure | 6 | 11 | 17 | |

Further, the standard milestones may include an engineering standard milestone, a procurement standard milestone, a construction standard milestone, or a combination thereof.

The standard activity information may include a list of standard activities and standard durations.

Further, the standard activities may include an engineering standard activity, a procurement standard activity, a construction standard activity, or a combination thereof.

The standard duration is a value that defines the required duration for each standard activity and is configured in the form of minimum value/reference value/maximum value, which helps an optimization algorithm derive an optimal solution by modifying the duration of activities when establishing a schedule.

Further, the standard durations may include an engineering standard duration, a procurement standard duration, a construction standard duration, or a combination thereof.

The standard durations are defined by reflecting characteristics for each activity classification criteria. The classification criteria are as follows.

In particular, engineering standard activities as defined according to the engineering standard document classification system, are classified as deliverable type (products submitted) or non-deliverable type (those without products, such as meetings, workshops, or information transmission), and defined for each engineering stage unit (here, stage refers to working procedure). In addition, the engineering stages (i.e., engineering working procedure) are interlocked with engineering major milestones so that engineering standard durations can be calculated in accordance with engineering standard milestones.

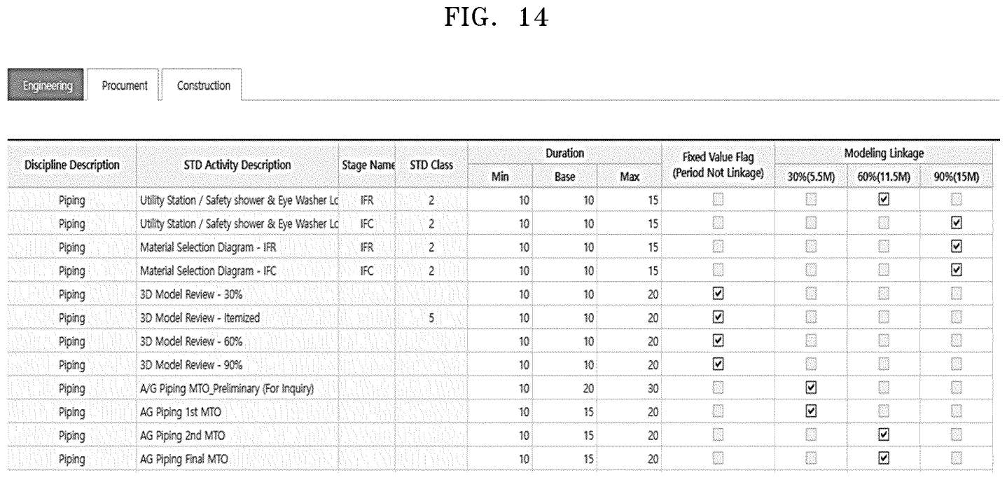

Table 2 shows the configuration of an engineering standard activity according to standard document classification system, and FIG. 14 shows a list of engineering standard durations for each engineering standard activity.

TABLE 2

| | | | | | Total en- |
|---|---|---|---|---|---|
| | Standard document classification system | | | | gineering |
| | | | Non | | Standard |
| Discipline | Type | Stages | Stage | Count | activity |
| Basic Material | Deliverable | 1 | 0 | 1 | With |
| Building | Deliverable | 6 | 0 | 6 | stage, |
| Civil | Deliverable | 22 | 0 | 22 | standard |
| Electrical | Deliverable | 17 | 0 | 17 | activities |
| | Non Deliverable | 4 | 0 | 4 | are |
| Fire Fighting | Deliverable | 13 | 0 | 13 | defined |
| General | Non Deliverable | 0 | 72 | 72 | for each |
| HVAC | Deliverable | 7 | 0 | 7 | stage |
| Instrument | Deliverable | 28 | 0 | 28 | |
| | Non Deliverable | 3 | 0 | 3 | |
| Machinery | Deliverable | 3 | 0 | 3 | |
| Piping | Deliverable | 23 | 0 | 23 | |
| | Non Deliverable | 15 | 0 | 15 | |
| Process | Deliverable | 20 | 0 | 20 | |
| | Non Deliverable | 5 | 0 | 5 | |
| Stationary | Deliverable | 3 | 0 | 3 | |
| Steel | Deliverable | 8 | 0 | 8 | |
| Structure | Non Deliverable | 7 | 0 | 7 | |
| Stress | Deliverable | 5 | 0 | 5 | |

Further, procurement standard durations for procurement standard activities as defined according to the type of equipment or material are classified as item or bulk, and according to type, necessary standard steps (that is, procurement standard working procedures) are registered and the procurement standard durations are defined for each sub-step unit (e.g., purchase requisition, review of technical specs, price negotiation, contracting, purchasing, and shipping).

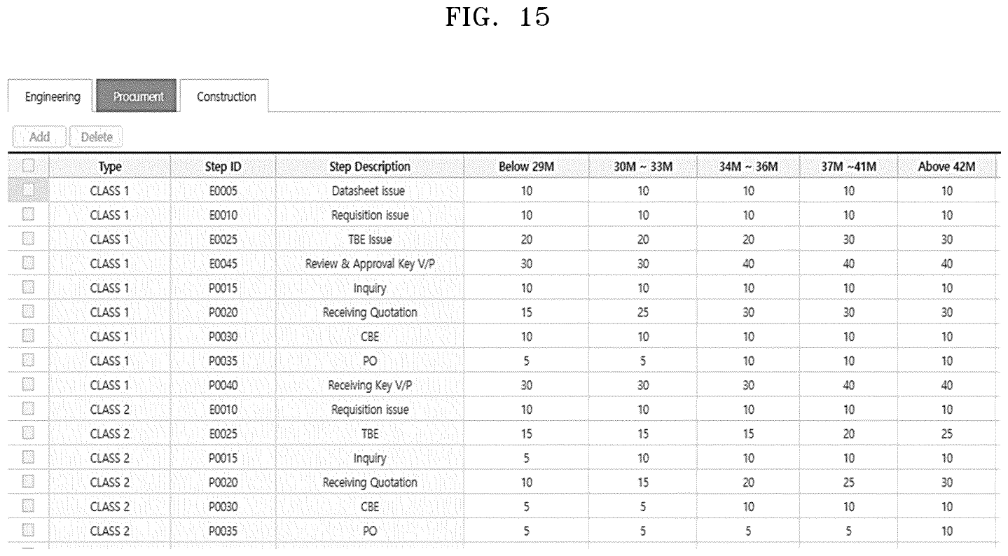

Table 3 shows the construction of procurement standard activities according to equipment or material type, and FIG. 15 shows a list of procurement standard durations for each standard step according to equipment or material type.

TABLE 3

| | | | Total |
|---|---|---|---|
| | Equipment or material type | | procurement |
| Discipline | Type | Count | Standard activity |
| Electrical | Bulk | 52 | Standard |
| | Item | 36 | activities are |
| HVAC | Item | 47 | defined for each |
| Instrument | Bulk | 35 | sub-step that |
| | Item | 187 | exists for each |
| Machinery | Bulk | 3 | equipment or |
| | Item | 128 | material type |
| Piping | Bulk | 149 | |
| | Item | 6 | |
| | Special Item | 65 | |
| Process | Item | 1 | |
| Stationary | Bulk | 3 | |
| | Item | 125 | |
| Steel Structure | Bulk | 9 | |

Further, as for construction standard activities defined in accordance with work classification criteria, intervals are divided according to the size of quantity for each activity, and the construction standard duration is defined for each interval. This is to utilize a construction standard duration by reflecting the size of project quantity inputted for each project, under the situation that construction standard activities are generated by combining the project data and standard activities.

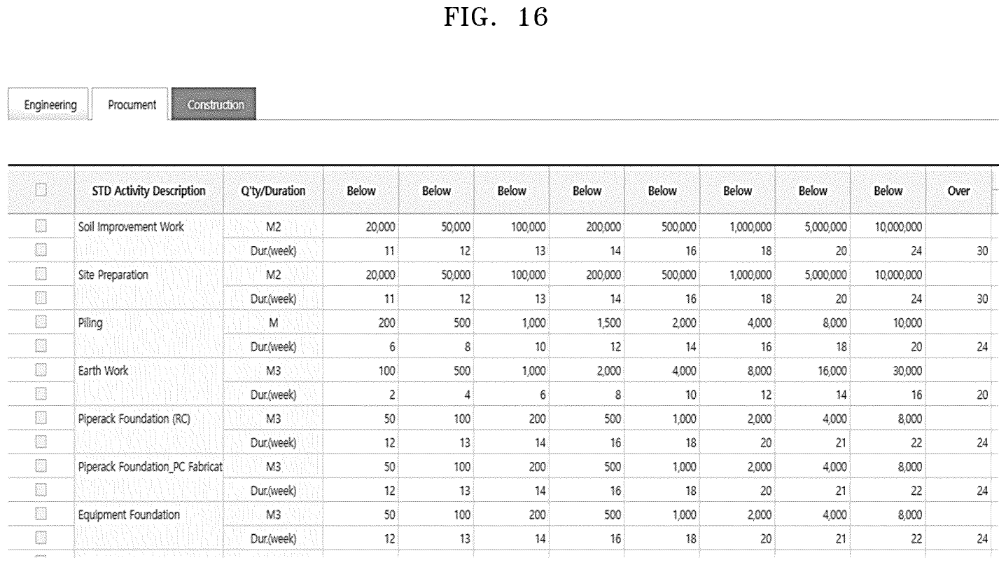

Table 4 shows the configuration of a construction standard activity based on work classification, and FIG. 16 shows a list of construction standard durations for each construction standard activity.

TABLE 4

| | Classified | Overall construction |
|---|---|---|
| Discipline | construction work | Standard activity |
| Building | 13 | Each classified work |
| Civil | 52 | is defined as standard |
| Commissioning | 1 | construction activity |
| Electrical | 21 | |
| Instrument | 13 | |
| Insulation | 3 | |
| Mechanical | 8 | |
| Module | 8 | |
| Painting | 3 | |
| Piping | 13 | |
| Pre-commissioning | 7 | |
| Start-Up & PAT | 1 | |
| Steel Structure | 6 | |
| Temporary | 2 | |

In addition, the standard relation refers to a predecessor-successor relation between standard activities, and is configured in the form of a relation type and lags. Relation defines a relation between two activities, and includes finish-to-start (FS), start-to-start (SS), and finish-to-finish (FF), and lag defines a delay between the preceding activity and its succeeding activity, and refers to the delayed period between the completion of the preceding activity and the start of its succeeding activity for FS relations, the delayed period between the start of the preceding activity and the start of the succeeding activity for SS relations, and refers to the delayed period between the completion of the preceding activity and the completion of the succeeding activity for FF relations.

Accordingly, standard relations may define up to 3 relation types (FS. SS. FF) and lags are configured in the form of minimum value/reference value/maximum value according to relation type.

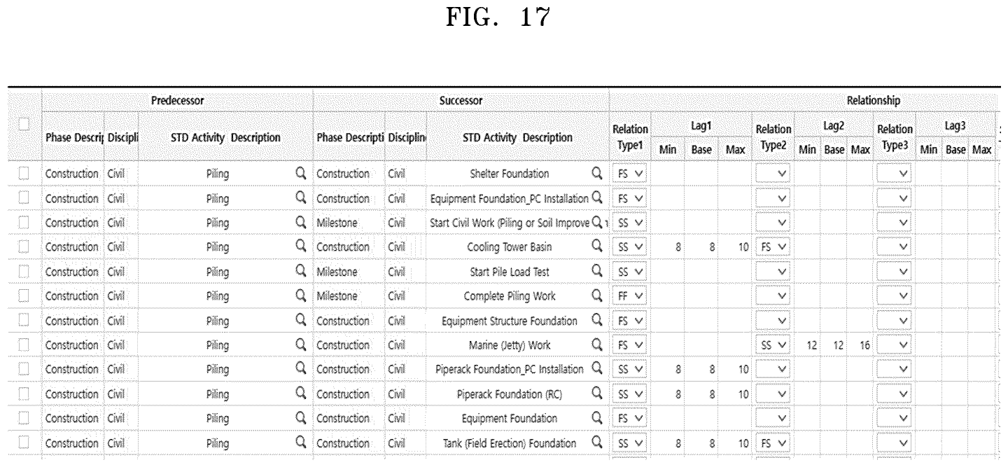

FIG. 17 shows a list of standard relations defined between standard activities.

Further, the standard relations may include an engineering standard relation, a procurement standard relation, a construction standard relation, or a combination thereof.

Standard durations and standard relations are defined in the form of a certain range rather than a fixed value, and determined according to relevant conditions in combination with drawing/equipment and material/construction quantity information of a project.

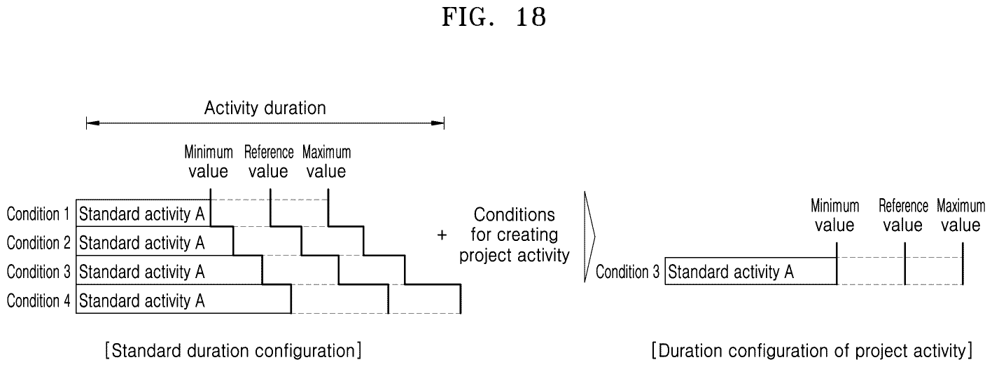

FIG. 18 shows the configuration and operation scheme of a standard duration.

As illustrate on the left of FIG. 18, the duration of standard activity has a form of minimum/reference/maximum values, where a single standard activity may have various duration values depending on its generation condition. For example, the conditions for creating the standard activity “equipment foundation installation” would be the amount of construction quantity, and the standard activity would have a duration of 4 weeks/5 weeks/6 weeks (minimum/reference/maximum values) when the construction quantity is 0 m³ to 50 m³, and a duration of 6 weeks/8 weeks/10 weeks when the construction quantity is 50 m⁴ to 200 in. a duration of 10 weeks/13 weeks/16 weeks when the construction quantity is 200 m³ to 500 m³, and a duration of 12 weeks/15 weeks/18 weeks if the construction quantity exceeds 500 in. Such a standard activity duration is combined with project information to determine an actual activity duration, and for example, the actual activity of equipment foundation installation with a quantity of 100 m³ may have an actual duration of 6 weeks/8 weeks/10 weeks.

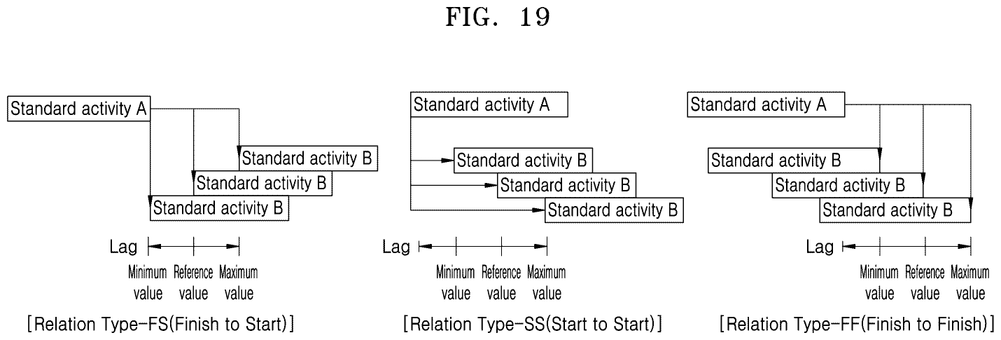

The standard relation defines a relation between two standard activities, and as illustrated in FIG. 19, may have three relation types. In the present system, when assigning a standard relation, minimum 1, maximum 3 relation types can be assigned, and priority may be assigned as Type-1, 2, and 3. Also, lags are not defined in the form of a range of minimum/reference/maximum values rather than a fixed value.

The present system is configured to enable detailed scheduling through activity-level adjustment by allowing modifications to be made to the duration and relation for individual activity. In addition, since a scheduling module establishes schedules based on pre-defined activity durations and relation within a changeable range, the scheduling results are provided with realistic activity durations and reflects logical and interpretable durations. Through this, uniform quality of the schedule results can be secured.

Referring back to FIG. 13, the project schedule version management module may include a project information registration module, a scheduling module, and a result analysis module.

The project information registration module may be configured to register work breakdown structure (WBS), calendar, milestone planning, and resource planning.

The milestone planning refers to selecting, from a standard milestone list, milestones to use in a particular project, and among these milestones, assigning target dates to those milestones required to comply with their respective dates, and the milestones assigned with target dates are specified as major milestones.

The schedule establishment method of the present system is a top-down method that establishes the schedule of detailed activities based on major milestone dates, and the scheduling optimization algorithm arranges activities to perform scheduling while the target dates of major milestones are fixed.

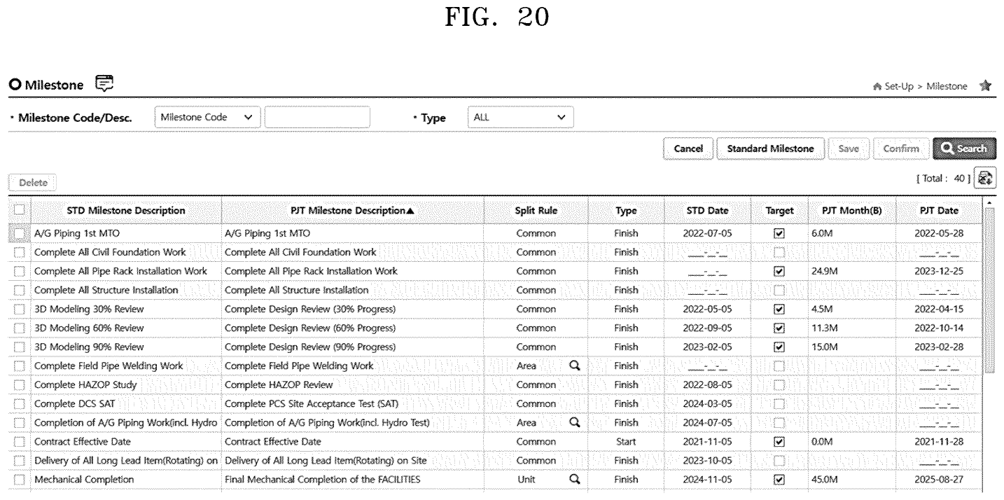

FIG. 20 shows a milestone input screen.

Referring to FIG. 20, on the milestone input screen, the milestone list being used in a particular project can be viewed, and milestones to be assigned with target dates are checked in the target column where target dates can be inputted in PJT Month or PJT Date column. For example, for 3D Modeling 30% Review milestone, 4.5 M (2022-04-15) may be inputted as target date.

The resource planning is a function to assign resources by dividing the total quantity and manpower for each activity into daily quantity and manpower during an activity duration, and may be utilized to establish a schedule in an upgrading direction (that is, a direction approaching a target value) by quantitatively measuring a resource loading result compared to a planned value in the schedule optimization step.

Planned resource values are inputted for each unit discipline, and for example, the total duration of a particular discipline is evenly divided into 20 intervals and a value is inputted for each interval. In particular, when establishing a schedule, for each unit discipline, the duration between the start date of the earliest activity and the finish date of the latest activity is evenly divided into 20 intervals, and evaluation is performed against the planned value for each interval.

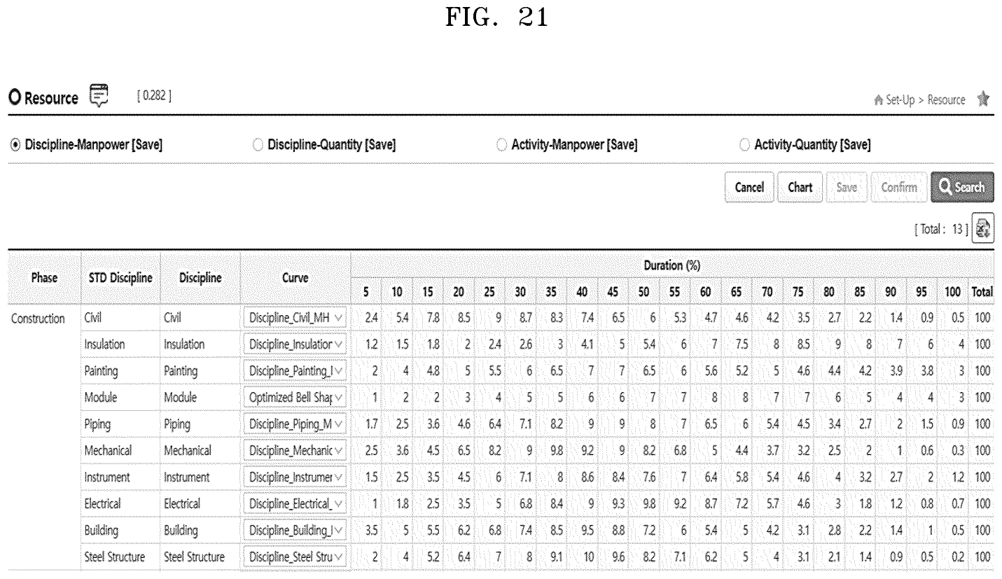

FIG. 21 shows an input screen for resource planning conditions.

The scheduling module may be configured to create an activity list by combining a project's drawing/equipment and material/quantity information with standardized schedule data. Here, the activities are generated based on the project's drawing/equipment and material/quantity information and thus can reflect the project's execution scope.

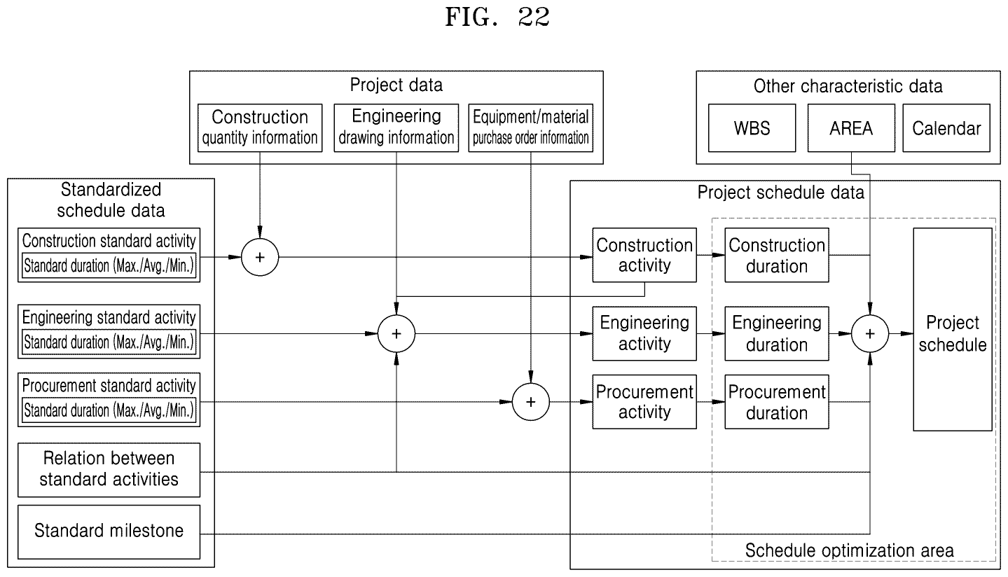

FIG. 22 illustrates an operation process of a method and system for automatic establishment of an optimal schedule for a construction project according to embodiments of the present invention.

As illustrated in FIG. 22, the process of creating a project activity list may be performed in a manner where the system automatically selects a list of target items to be created from a standard activity list based on project data (quantity, drawing, materials), wherein the user specifies a project activity creation unit for each of the selected standard activities. Here, the activity creation unit includes physical units, such as Common (project unification concept), Area, and Item, and equipment or material bundle units, such as MR (Material Requisition) and Equipment Group. In the present system, the activity creation unit is referred to as Object Type, and a subsequently generated attribute value is referred to as Object (e.g., if there are 100 pumps, each pump is an object). Accordingly, each activity has standard activity information, and Object Type and Object information, which may be utilized in generating relations between activities.

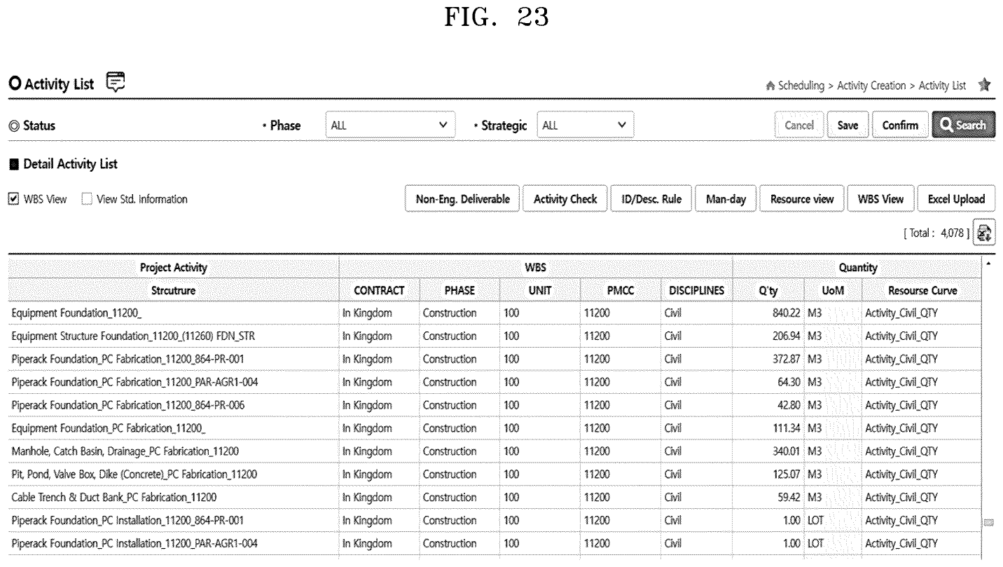

FIG. 23 shows a project activity generation scene.

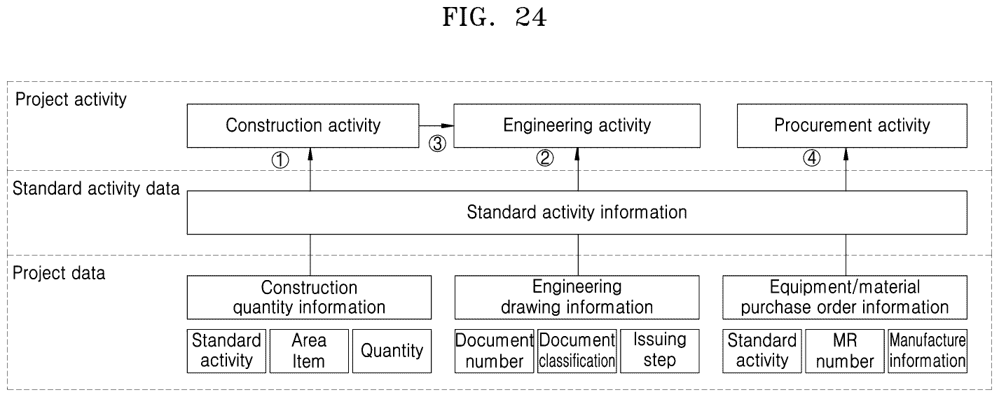

In particular, project activity creation data and method are different between engineering/procurement/construction, and details thereof are as illustrated in FIG. 24.

Referring to FIG. 24, the process of creating a construction activity list may be performed by searching construction standard activities included in construction quantity information, determining a construction standard activity list to be executed in a particular project, and assigning a project activity creation unit for each construction standard activity.

Since the construction quantity information includes standard activity and quantity for each detailed item, execution of a construction activity can be checked for each physical space of the corresponding project.

Document classification information is assigned to the standard activity information for each engineering standard activity, and by searching the document classification information included in engineering drawing information, a list of standard engineering activities to be executed in the corresponding project is determined.

In addition, engineering activity is the preceding activity for executing construction activity, and the engineering and the construction need to have the same Object information. In particular, the preceding engineering activity as defined by a standard relation is forced to have all Object information of its succeeding construction activity. For example, if there is no preceding engineering activity of construction activity, the present system forcibly creates the preceding engineering activity. As a result, the engineering and construction activities contain the same information so that they can refer to object information.

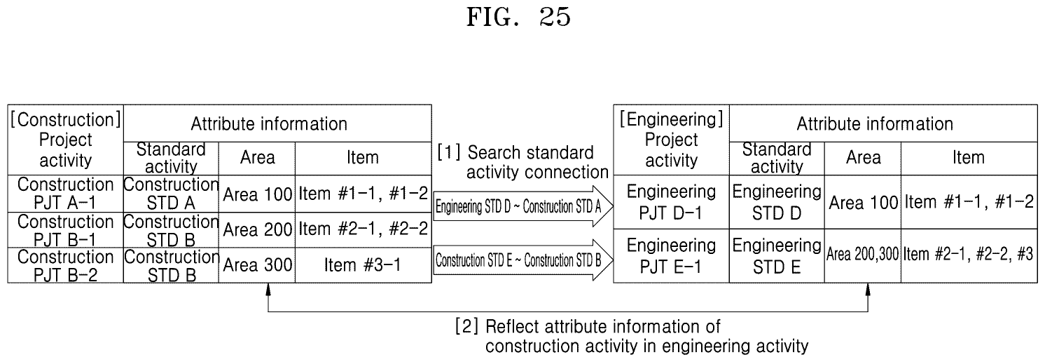

FIG. 25 illustrates a method of generating attribute information of engineering activities.

As illustrated in FIG. 25, a construction standard activity connected to an engineering standard activity is searched in standard activity relation information. For example, engineering STD D-construction STD A, and engineering STD E-construction STD B are searched. Then, the present system allows the engineering activity to reflect the object information of the construction activity whose connection has been confirmed above.

Next, project procurement activities are generated for each project MR included in equipment/material purchase order information, and based on standard procurement activity information assigned to each MR, procurement work steps are automatically assigned.

Next, the project activity created above automatically calculates the duration based on the standard activity.

Next, the process of generating activity relations is a step of generating relation data between preceding activities and succeeding activities and is performed by searching succeeding activities for all the activities. Searching succeeding activity involves first extracting a candidate group of succeeding activities for each standard activity, and then comparing Objects between activities to determine whether to generate a relation.

In particular, searching succeeding activity involves searching a candidate group of activities that can be connected as a successor by referring to predecessor-successor relation information between standard activities registered in standard relations.

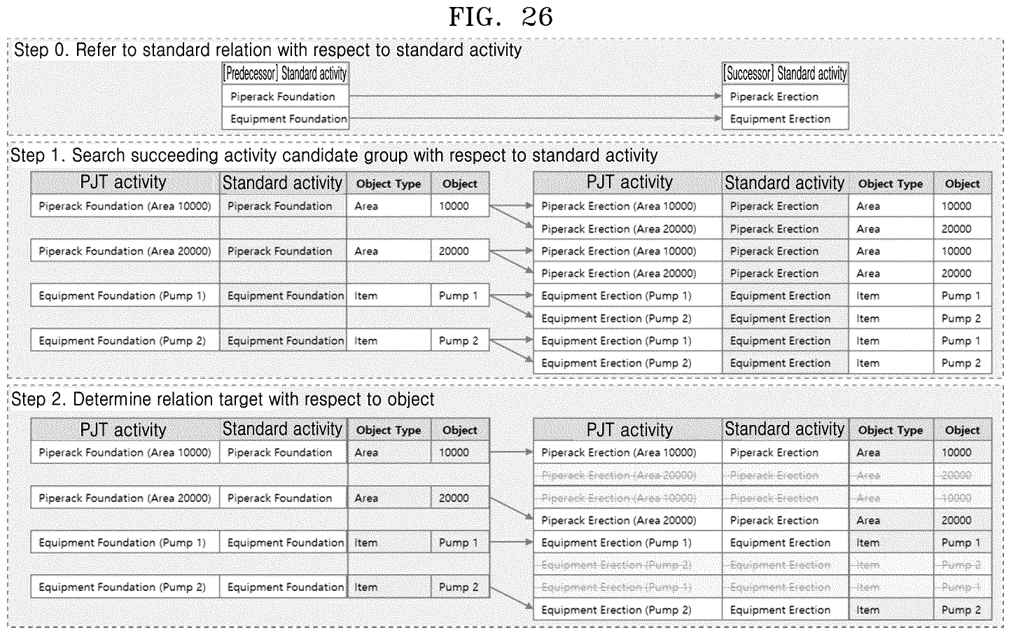

Next, as shown in FIG. 26 illustrating a method of generating relations at each step, as shown at “Step 0”, there is provided standard relation information with respect to a standard activity where preceding activity is Piperack Foundation and succeeding activity is Piperack Erection. Based thereon, as shown at “Step 1”, for each of the two preceding PJT activities, two candidates for the succeeding PJT activities are searched, and a total of four relation candidates are selected.

The next step is to select the final succeeding activity through Object comparison, and as shown at “Step 2”, the succeeding activity is selected through Object comparison of the preceding and succeeding PJT activities for the relation candidate group. In the example illustrated in the figure, since the Object Type of Piperack Foundation and Piperack Erection is Area, a relation that the preceding and succeeding PJT activities have the same Area is determined as the final relation.

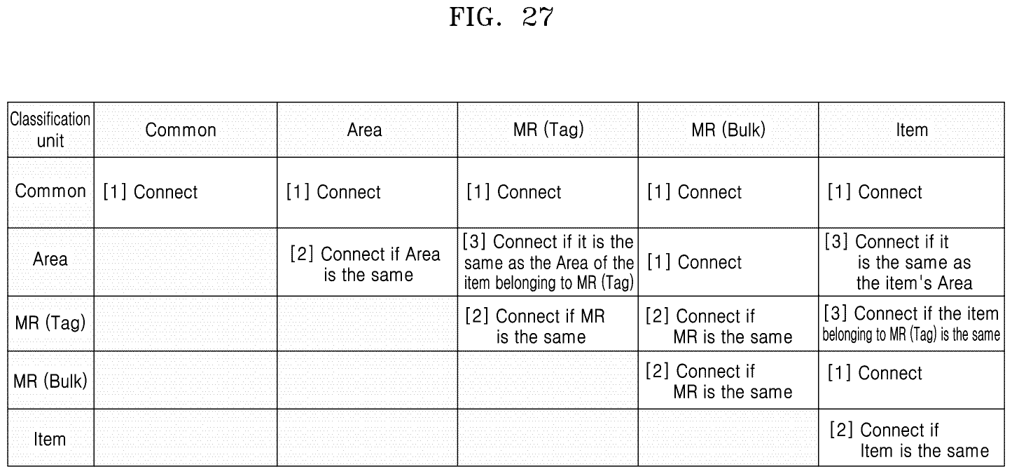

In addition, the object comparison method for each Object Type is summarized in FIG. 27 showing predecessor-successor relation condition between 2-step objects, and the detailed contents are as follows.

That is, “Common” means the scope of the entire project, so it is a method of connecting without comparing objects, and examples of standard activities having this Object Type include Project Execution Plan, Material Take-Off, Site Survey, and the like.

“Area” refers to a physical division of a project construction site and generally refers to a zone, and most engineering activities are created for each Area as illustrated in FIG. 26.

“MR” means a unit that bundles similar equipments or materials to purchase equipments or materials, “Tag” is classified for each item since individual equipment or material such as machines and valves may have different specifications from each other, and “Bulk” refers to universally used equipment or material, such as cables and pipes. For example, a machine such as Pump 1 or Pump 2 is purchased with MR (Tag) called Pump, and a 1-inch-diameter pipe or 2-inch-diameter pipe is purchased with MR (Bulk) called Pipe.

The reason “MR” is divided into “Tag” and “Bulk” is that since MR (Tag) is a unit that bundles individual items, when comparing Object as shown in “Step 2” in FIG. 26, a decision on whether to establish a relation has to be made for individual item, whereas MR (Bulk), since it indicates universal equipment or material, establishes a relation logic that allows the corresponding equipment to be used in all Areas.

Item is a unit of individual items, and generally includes machinery, machinery foundation, building, or steel structures.

As illustrated in FIG. 27. [1] is a logic that encompasses the entire project and therefore makes connection regardless of Object, [2] compares Objects and makes connection only if Objects are the same, and [3] refers to MR (Tag) and Area information of Items and makes connection only if two corresponding MRs (Tag) are the same and two corresponding Areas are the same.

Referring back to FIG. 13, the scheduling module may be configured to perform activity creation, duration generation, relation generation, and schedule optimization.

In particular, the scheduling module performs the task of deriving an optimal schedule result with aim to comply with the target date of a major milestone and the target loading for each discipline. To this end, a metaheuristics-based optimization scheduling algorithm is established, and the method of quantitatively evaluating the derived schedules is defined.

In particular, the scheduling optimization module, as described with reference to FIG. 3 above, may perform the following steps: a schedule data pre-review step; a milestone target date review step; a step of selecting activities on a driving path and selecting activities on an entire critical path for each milestone; an activity loading adjusting step; and a schedule quantitative evaluation step.

Referring back to FIG. 13, the result analysis module may be configured to perform the following steps: a milestone date and loading result checking step; a quantitative evaluation result analyzing step; and a step of transmitting data to a scheduling program.

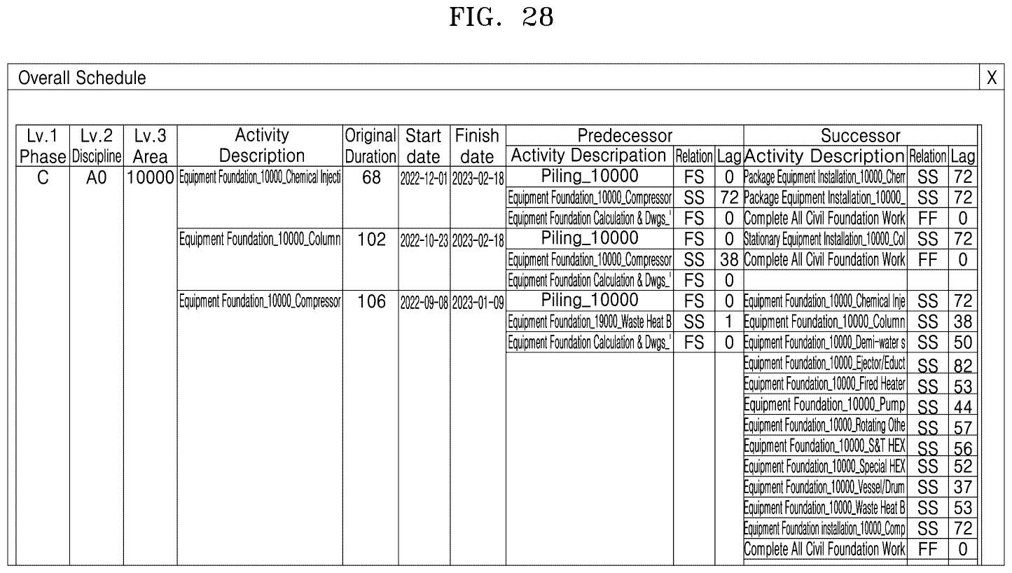

In particular, after the termination of scheduling optimization through the scheduling optimization module, as illustrated in FIG. 28, a final output project schedule is generated and the final output project schedule may be interfaced with a scheduling tool (e.g., Primavera 6) and viewed through the scheduling tool.

Further, the present system allows detailed results such as a start date, a finish date, a duration and a relation, to be viewed for each activity, and provides milestone date compliance, driving path, critical path, and quantitative evaluation result analysis screens to enable a more comprehensive and convenient analysis of schedule results.

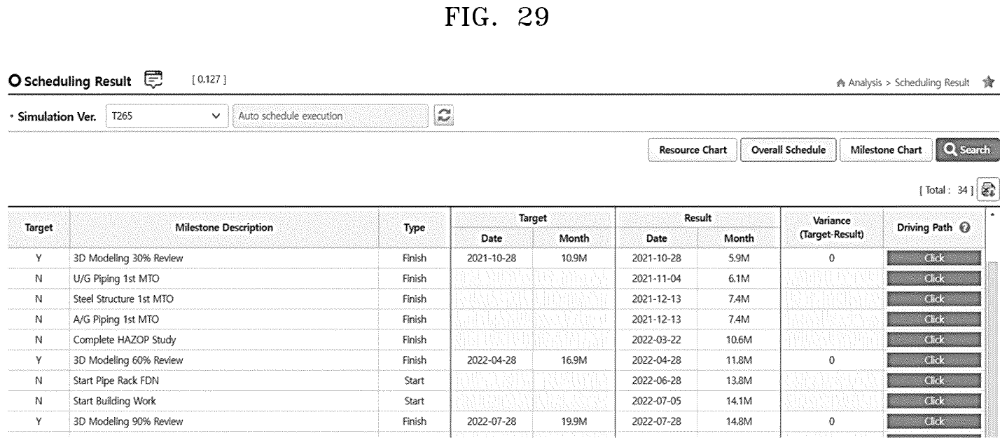

FIG. 29 shows a milestone result analysis screen.

As shown in FIG. 29, on the milestone result analysis screen, the result date and target compliance state can be viewed for each milestone. On this screen, the date results (Result column), target dates (Target column), and vs. target compliance results (Variance column) for all milestones specified in a corresponding project are displayed.

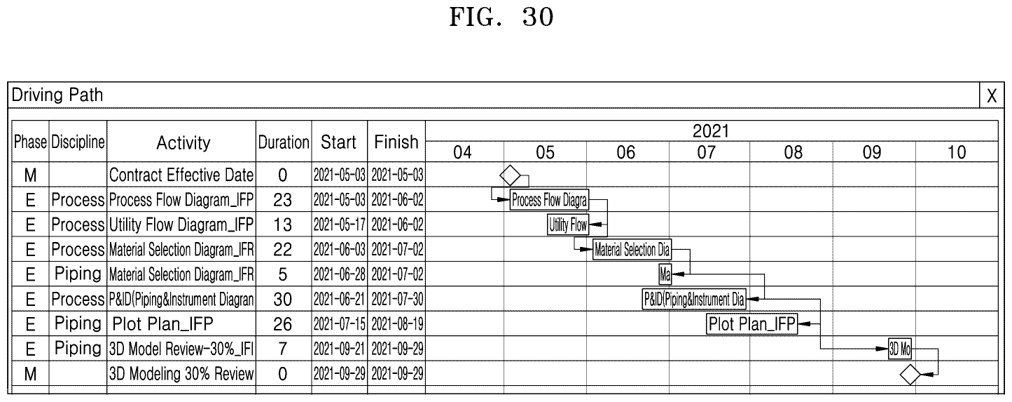

FIG. 30 shows a driving path screen.

As shown in FIG. 30, it is possible to see how the result date is established, according to milestone, through the driving path function. That is, by checking on the driving path according to milestone, the user can easily see which activities are to be adjusted for project schedule adjustment, or which activities to manage with extra care, in order to comply with the assigned dates during project execution.

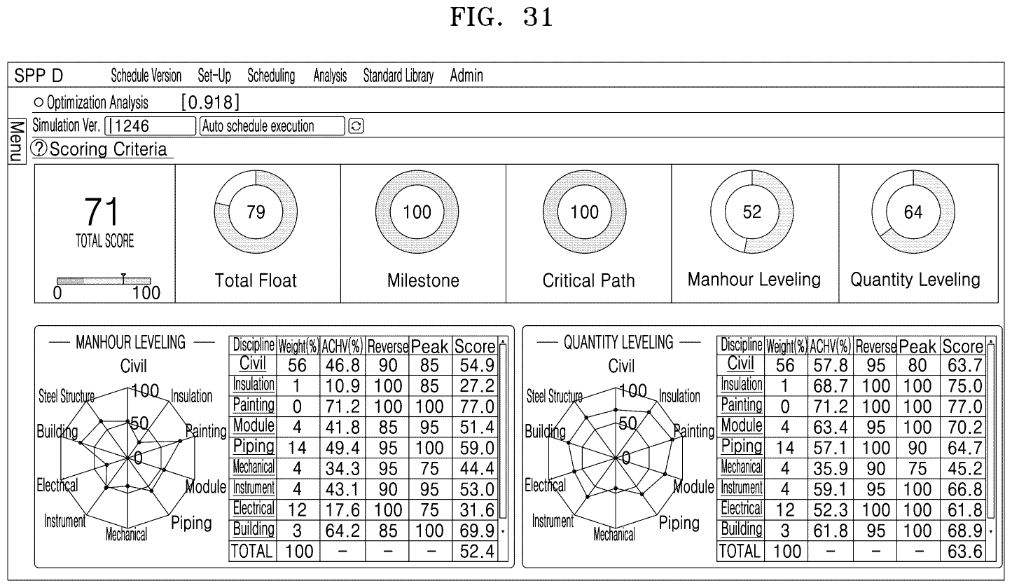

FIG. 31 shows an overall evaluation result screen.

As shown in FIG. 31, the overall evaluation result screen provides an overall schedule evaluation score in terms of five evaluation criteria. However, since each project has different activity configuration, milestone target dates, and loading target, it may be difficult to use this score as an indicator of comparison between projects, but within the same project, can be used as an indicator that indicates technical integrity.

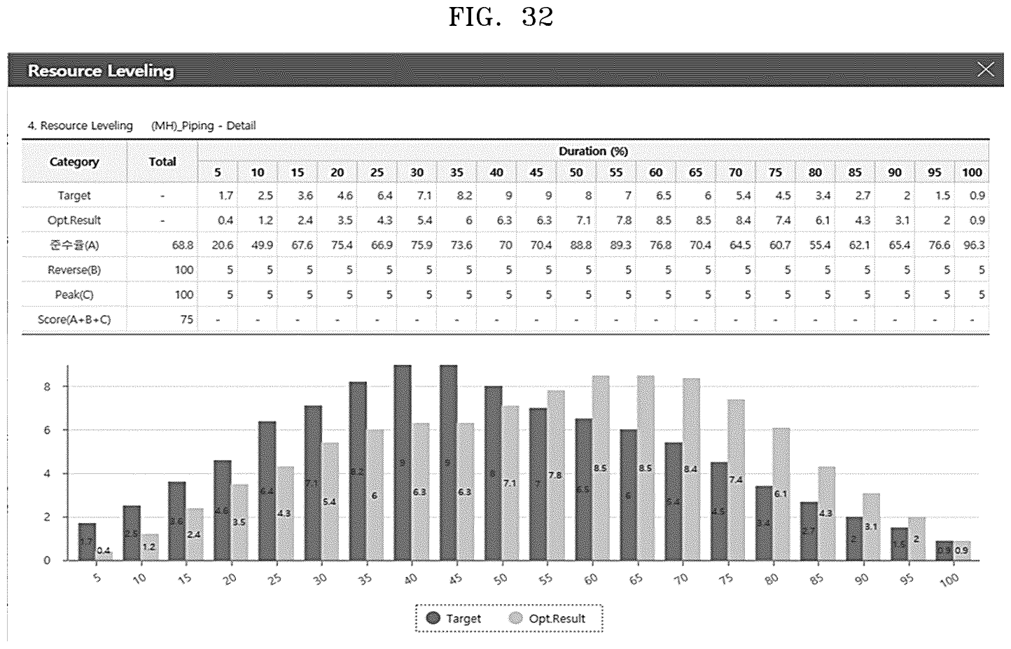

FIG. 32 shows a discipline evaluation result screen.

As shown in Table 5 below, the method and system for automatic establishment of an optimal schedule for a construction project according to embodiments of the present invention, having the above features, may be able to reduce the man-hour (M/H) required for project/proposal data collection and schedule establishment.

TABLE 5

| | Prior art | The present invention |
|---|---|---|
| Project | 8 Hr per day × 20 days × 3 | 8 Hr per day × 3 days × |
| | months × 4 crew members × | 2 crew members × 5 |
| | 5 items = 9,600 M/H | items = 240 M/H |
| | (Overseas plant construction | (Overseas plant construction |
| | expected) | expected) |
| Proposal | 8 Hr per day × 20 days × 3 | 8 Hr per day × 3 days × 1 |
| | months × 1 crew member × | crew member × 15 items = |
| | 15 items = 7,200 M/H | 360 M/H |
| | (Overseas plant construction | (Overseas plant construction |
| | expected) | expected) |

While one or more embodiments have been described with reference to the figures, it will be understood by those of ordinary skill in the art that various changes in form and details may be made therein. Therefore, the full scope of technical protection for the present invention shall be defined by the technical concept of the following claims.

1. A computer-implemented method of automatic establishment of an optimal schedule for a construction project, the method comprising:
providing project data, standardized schedule data, and characteristic data (S10);
generating project schedule data by combining the project data, the standardized schedule data, and the characteristic data (S20); and
deriving an optimal project schedule by processing the project schedule data through a scheduling optimization algorithm (S30).

2. The method of claim 1,
wherein the project data comprises drawing information, material information, quantity information, manpower information, a standard library of the project, or a combination thereof,
wherein the standardized schedule data comprises a standard activity, a standard duration, a standard relation, or a combination thereof,
wherein the characteristic data comprises an area, a calendar, a milestone, a work breakdown structure, or a combination thereof,
wherein the project schedule data comprises an actual activity, an actual duration, an actual relation, or a combination thereof, each reflecting the project information.

3.-5. (canceled)

6. The method of claim 1,
wherein the scheduling optimization algorithm comprises a milestone and critical path scheduling sub-algorithm and a loading optimization sub-algorithm.

7. The method of claim 6,
wherein the milestone and critical path scheduling sub-algorithm comprises a schedule data pre-review step, a major milestone target date compliance probability review step, a major milestone driving path selection step, and a critical path selection step.

8. The method of claim 7,
wherein the schedule data pre-review step is a step of checking on whether relations are closed and whether it is possible to comply with a finish milestone date,
wherein the major milestone target date compliance probability review step comprises arranging all activities consecutively in a direction from finish milestone to start milestone of the project by using standard durations and standard relations of the activities; and adjusting the activities sequentially in a direction from the start milestone to the finish milestone of the project with the aim of complying with the major milestone target date,
wherein the adjustment of the activities is achieved by an equal adjustment and a fine adjustment, wherein the equal adjustment adjusts the durations and lags of all activities in a path by an equal proportion, and the fine adjustment makes an individual adjustment to a duration, lag, relation, or a combination thereof, of an individual activity in a path,
wherein the selection of the major milestone driving path comprises generating a plurality of paths by modifying durations, relations, or a combination thereof of the activities, with respect to all milestones between, but not including a start milestone and a finish milestone; and from among paths generated by applying durations and relations of activities as reference values, selecting a path having the longest duration as a driving path and excluding the remaining paths from the driving path,
wherein the critical path selection step comprises generating a plurality of paths by modifying a duration, a relation or a combination thereof of an activity, with respect to the finish milestone, wherein an activity pre-specified by a user is included in each of the paths; and from among the plurality of paths, selecting a critical path according to the following priorities (1) to (3);
(1) first priority: the path in which the greatest number of the user-specified activities are included,
(2) second priority: if a plurality of first priority paths exist, the longest path when the duration and relation are reference values, and
(3) third priority: if a plurality of second priority paths exist, the path having the largest number of activities.

9.-12. (canceled)

13. The method of claim 6,
wherein the loading optimization sub-algorithm comprises: adjusting activity loading; quantitatively evaluating the activity loading; deciding whether a quantitative evaluation result is superior to an optimal solution; storing the quantitative evaluation result as an optimal solution; deciding whether an optimization termination condition is met; and terminating scheduling optimization.

14. The method of claim 13,
wherein the adjustment of activity loading is performed through rearrangement of activities by discipline.

15. The method of claim 14,
wherein the loading optimization sub-algorithm repeatedly performs a unit execution cycle consisting of a forward optimization and a backward optimization, wherein the forward optimization performs optimization in a reverse order of disciplines from a final discipline to a start discipline, by rearranging activities to the later time points that a total score can be increased, and wherein the backward optimization performs optimization in a forward direction of disciplines from the start discipline to the final discipline, by rearranging activities to the previous time points that a total score can be increased.

16. The method of claim 15,
wherein the forward optimization and the backward optimization each include a partial interval optimization and an entire interval optimization, wherein the partial interval optimization refers to a step of causing a small number of activities temporally spaced apart from an activity cluster to be temporally close to the activity cluster, and the entire interval optimization refers to a step of performing optimization on all the activities of a discipline.

17. The method of claim 13,
wherein the quantitative evaluation of activity loading comprises calculating a total score by combining a float-based schedule score, a milestone-based schedule score, a critical path-based schedule score, a manhour leveling-based schedule score, and a quantity leveling-based schedule score,
wherein the float-based schedule score may be calculated by multiplying a first point calculated according to Equation 1 by a corresponding weight factor,
the milestone-based schedule score is calculated by multiplying a second point calculated according to Equation 2 by a corresponding weight factor, and
the critical path-based schedule score is calculated by multiplying a third point calculated according to Equation 3 by a corresponding weight factor.
First point (%)=(1−the number of activities having a total float of 200 days or more/the total number of activities)×100 [Equation 1]
Second point (%)=the number of the user-specified milestones on schedule/the total number of the user-specified milestones×100 [Equation 2]
Third point (%)=the number of the reference activities in the critical path/the number of the reference activities for establishing the critical path×100 [Equation 3]

18. The method of claim 17,
wherein the manhour leveling-based schedule score and the quantity leveling-based schedule score are each calculated by combining a target compliance rate-based schedule score, a reverse-based schedule score, and a peak over-based schedule score, and
wherein when a duration from the start date of the earliest activity to finish date of the latest activity among activities included in a corresponding discipline is evenly divided into a plurality of intervals, the target compliance rate-based schedule score, the reverse-based schedule score, and the peak over-based schedule score are each calculated based on a corresponding weight factor and a point evaluated for each interval,
wherein the target compliance rate-based schedule score is calculated by multiplying an average value of fourth points calculated according to Equation 4 for each interval by a corresponding weight factor, and
where the reverse-based schedule score and the peak over-based schedule score are each calculated by multiplying the sum of scores of all non-reverse intervals and all reverse intervals by a corresponding weight factor:
Fourth Point (%)=The smaller of the target value and the result value/The larger of the target value and the result value×100 [Equation 4].

19. The method of claim 13,
wherein the decision on whether the quantitative evaluation result is superior to the optimal solution is immediately followed by the storing of the quantitative evaluation result as the optimal solution if the decision is ‘Yes’, and is immediately followed by the adjustment of activity loading if the decision is ‘No’,
wherein the decision on whether the optimization termination condition is met is immediately followed by the termination of scheduling optimization if the decision is ‘Yes’, and is immediately followed by the adjustment of activity loading if the decision is ‘No’,
wherein the optimization termination conditions is to satisfy a maximum execution cycle or a maximum duration.

20.-21. (canceled)

22. A system for automatic establishment of an optimal schedule for a construction project, the system being configured to execute the method according to claim 1, and the system comprising:
a standard data version management module; and
a project schedule version management module.

23. The system of claim 22,
wherein the standard data version management module comprises a standard data management module, and
the standard data management module is configured to manage information of standard milestones, information of standard activities, standard durations, standard relations, or a combination thereof.

24. The system of claim 23,
wherein the standard milestones are classified as a start type or a finish type
wherein the standard durations are configured in the form of minimum value/reference value/maximum value,
wherein the standard relations are predecessor-successor relations defined between two standard activities and are configured in the form of a relation type and a lag, wherein the relation type includes Finish-to-Start (FS), Start-to-Start (SS), Finish-to-Finish (FF), or a combination thereof.

25. The system of claim 23,
wherein the standard milestones comprise an engineering standard milestone, a procurement standard milestone, a construction standard milestone, or a combination thereof,
the standard activities comprise an engineering standard activity, a procurement standard activity, a construction standard activity, or a combination thereof,
the standard durations comprise an engineering standard duration, a procurement standard duration, a construction standard duration, or a combination thereof, and
the standard relations comprise an engineering standard relation, a procurement standard relation, a construction standard relation, or a combination thereof.

26. The system of claim 25,
wherein the engineering standard activity is classified as a deliverable type or a non-deliverable type depending on the existence of engineering output, and is defined for each engineering stage interlocked with the engineering standard milestone, and
the engineering standard duration is calculated according to the engineering standard milestone.

27. The system of claim 25,
wherein the procurement standard activity is classified as item or bulk depending on the type of equipment or material, and is defined for each sub-procurement stage that exists for each equipment or material type, and
the procurement standard duration is defined for each procurement standard stage registered for each equipment or material type.

28. The system of claim 25,
wherein the construction standard activity is defined according to work classification criteria,
and the construction standard duration may be divided into a plurality of intervals according to the size of quantity for each activity, and is defined for each interval.

29.-30. (canceled)

31. The system of claim 22,
wherein the project schedule version management module comprises a project information registration module, a scheduling module, and a result analysis module,
the project information registration module is configured to register a work breakdown structure, a calendar, milestone planning, resource planning, a project data interface, or a combination thereof,
the scheduling module is configured to perform activity creation, duration generation, relation generation, and schedule optimization, and
the result analysis module is configured to perform milestone date and loading result check, quantitative evaluation result analysis, and data transmission to a scheduling program.
